(19) United States
(12) Patent Application Publication
(10) Pub. No.: US 2011/0104935 A1
(43) Pub. Date: May 5, 2011

(54) CONNECTOR AND ILLUMINATING DEVICE EQUIPPED WITH THE CONNECTOR

(75) Inventors: Yoshiyuki Kitamura, Osaka-shi (JP); Susumu Kitamura, Osaka-shi (JP); Noritaka Okamura, Osaka-shi (JP); Hiroyasu Nakagawa, Osaka-shi (JP); Shoji Yamamoto, Osaka-shi (JP)

(73) Assignee: SHARP KABUSHIKI KAISHA, Osaka-shi, Osaka (JP)

(21) Appl. No.: 13/000,283

(22) PCT Filed: Jun. 9, 2009
(86) PCT No.: PCT/JP2009/060505

§ 371 Date: Jan. 10, 2011

(30) Foreign Application Priority Data
Jun. 20, 2008 (JP) 2008-162325
Jun. 20, 2008 (JP) 2008-162326

(51) Int. Cl. H01R 13/00

(52) U.S. Cl. 439/485

(57) ABSTRACT

A connector according to the present invention connects a conductive member such as a radiating section which radiates generated heat from a heat source functioning with supplied power and a power connection section which connects with an external power source supplying power to the heat source.

The connector is characterized by having electrical insulation properties in order to electrically insulate the conductive member and the power connection section, and having thermal resistance in order to prevent deformation due to heat from the heat source.

This application is the national phase under 35 U.S.C. §371 of PCT International Application No. PCT/JP2009/060505 which has an International filing date of Jun. 9, 2009 and designated the United States of America.

### BACKGROUND

1. Technical Field

The present invention relates to a connector for connecting a conductive member, such as a radiating section, to a power source connection section, such as a cap, and to an illuminating device equipped with the connector.

2. Description of Related Art

In recent years, illuminating devices incorporating light-emitting diodes (hereafter referred to as LEDs) as light sources have been developed, and LED bulbs incorporating LEDs as light sources have been proposed (for example, Japanese Patent Application Laid-open Publication No. 2006-313717).

FIG. 1 is a vertical sectional view showing a conventional LED bulb 201 described in Japanese Patent Application Laid-open Publication No. 2006-313717. In the LED bulb 201, LEDs 202 serving as point-like light sources are mounted on a light-source mounting section 203; the heat generated from the LEDs 202 is transferred via the light-source mounting section 203 to an outer shell member 204 made of metal and serving as a radiating section and radiated from the outer shell member 204 to the outside air.

Furthermore, on the opening end side of the outer shell member 204, the above-mentioned LED bulb 201 has a cap 206 having wires for electrically connecting a lighting circuit 205 accommodated inside the outer shell member 204 to an external power source, and the outer shell member 204 is connected to the cap 206 via a connecting member 207 made of a synthetic resin and serving to ensure electrical insulation therebetween.

### SUMMARY

However, although the outer shell member 204 and the cap 206 are electrically insulated since the connecting member 207 used for the above-mentioned conventional LED bulb 201 is made of a synthetic resin, if the lighting circuit 205 inside the outer shell member 204 is ignited, there occurs a problem that the connecting member 207 is melted by the heat for example and deformed and the connecting member 207 itself is ignited in some cases.

Furthermore, there also occurs a problem that, depending on the type of the synthetic resin used for the connecting member 207, the connecting member is deformed even by such a degree of heat transferred from the LEDs 202 and/or the lighting circuit 205 via the outer shell member 204. In particular, since semiconductor light-emitting devices, such as LEDs, generate a large amount of heat, the amount of heat to be transferred to the outer shell member 204 becomes large, and there is a high possibility that the connecting member 207 making contact with the outer shell member 204 may be deformed. Hence, it is necessary that the connecting member 207 performs connection while ensuring electrical insulation between the outer shell member 204 and the cap 206 and is prevented from being deformed by heat.

A connector according to the present invention is a connector for connecting a conductive member, such as a radiating section for radiating heat generated by a heat source which functions with supplied power, to a power source connection section connected to an external power source which supplies power to the heat source, being characterized in that the connector has electrical insulation properties to electrically insulate the above-mentioned conductive member and the above-mentioned power source connection section and has heat resistance so as to be prevented from being deformed due to heat from the heat source.

In the present invention, the connector can connect the conductive member, such as the radiating section, for radiating the heat generated from the heat source operating on supplied power to the power source connection section connected to the external power source for supplying power to the heat source while ensuring electrical insulation and can be prevented from being deformed due to heat.

The connector according to the present invention is a connector for connecting a conductive member, such as a radiating section for radiating heat generated by a light source and/or a drive circuit section, to a cap connected to an external power source which supplies power to the light source, being characterized in that the connector has electrical insulation properties to electrically insulate the above-mentioned conductive member and the above-mentioned cap and has heat resistance so as to be prevented from being deformed due to heat.

In the present invention, the connector can connect the conductive member, such as the radiating section, to the cap while ensuring electrical insulation and can be prevented from being deformed due to heat.

The connector according to the present invention is further characterized in that it has noncombustibility.

In the present invention, the connector itself can be prevented from being ignited by the heat transferred from a light source module and/or a drive circuit section serving as the heat sources.

The connector according to the present invention is further characterized in that it is made of porcelain.

In the present invention, since porcelain has electrical insulation properties and has a high melting point, it can be prevented from being deformed. In addition, since porcelain is high in hardness, the connector can be prevented from being deformed due to impact from the outside.

The connector according to the present invention is further characterized in that it is further equipped with a first screw-engaging structure for screw-engaging the above-mentioned connector with the above-mentioned conductive member and/or a second screw-engaging structure for screw-engaging the above-mentioned connector with the above-mentioned power source connection section or the above-mentioned cap.

In the present invention, since the connector has the first screw-engaging structure for screw-engaging the connector with the above-mentioned conductive member and/or the second screw-engaging structure for screw-engaging the above-mentioned connector with the above-mentioned power source connection section or the above-mentioned cap, the respective members can be connected easily.

The connector according to the present invention is further characterized in that the above-mentioned first screw-engaging structure and/or the above-mentioned second screw-engaging structure are obtained by being formed a male thread on the connector.

In the present invention, since the male thread is formed on the connector being low in molding accuracy, the productivity of the connector can be improved, and the yield thereof can be improved.

The connector according to the present invention is further characterized in that the convex section of the above-mentioned male thread has a rounded shape.

In the present invention, since the convex section of the male thread provided on the connector has the rounded shape, the rounded shape is more difficult to be cracked than an angular shape.

The connector according to the present invention is further characterized in that the above-mentioned first screw-engaging structure and/or the above-mentioned second screw-engaging structure are provided with a sealing material for screw-engaging.

In the present invention, the connector and the conductive member, such as the radiating member, and/or the connector and the power source connection section, such as the cap, can be connected hermetically. In addition, the engagement can be carried out firmly.

The connector according to the present invention is further characterized in that the above-mentioned connector is coated with glaze.

In the present invention, the unevenness on the surface of the porcelain constituting the connector can be smoothed.

An illuminating device according to the present invention is characterized in that it is equipped with the above-mentioned connector.

In the present invention, it is possible to provide an illuminating device capable of connecting the conductive member, such as the radiating section, to the cap while ensuring electrical insulation therebetween and capable of preventing the connector from being deformed due to heat.

The illuminating device according to the present invention is further characterized in that the above-mentioned light source is a light-emitting diodes.

In the present invention, it is possible to provide an illuminating device capable of connecting the conductive member, such as the radiating section, to the cap while ensuring electrical insulation therebetween and capable of preventing the connector from being deformed due to heat even in the case that the light source is formed of light-emitting diodes having a large amount of heat generation.

With the present invention, it is possible to connect the conductive member, such as the radiating section, to the power connection section, such as the cap, while ensuring electrical insulation therebetween and to prevent the connector from being deformed due to heat.

The above and further objects and features will more fully be apparent from the following detailed description with accompanying drawings.

### BRIEF DESCRIPTION OF THE SEVERAL VIEWS OF THE DRAWINGS

FIG. 1 is a vertical sectional view showing the conventional LED bulb.

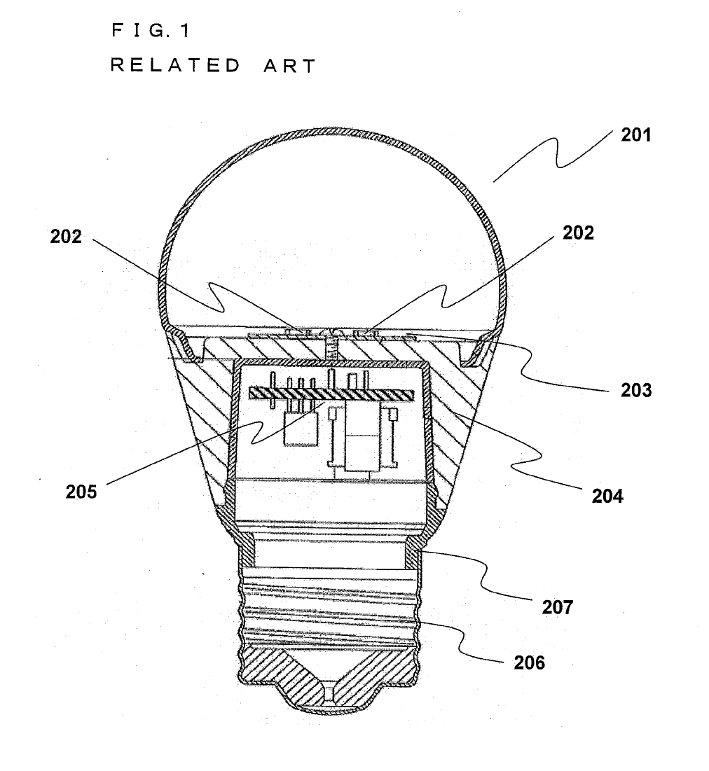

FIG. 2 is a perspective view showing the main section of an illuminating device according to Embodiment 1 of the present invention;

FIG. 3 is an exploded perspective view showing the main section of the illuminating device shown in FIG. 2;

FIG. 4 is a vertical half-sectional view showing the main section of the illuminating device shown in FIG. 2;

FIG. 5 is a vertical sectional view showing the main section of the illuminating device shown in FIG. 2;

FIG. 6 is a schematic view showing a light source module for use in the illuminating device shown in FIG. 2;

FIG. 7A is a view illustrating a state in which the light source module and a reflection section are mounted on the light-source mounting face of the illuminating device shown in FIG. 2;

FIG. 7B is a view illustrating a state in which the light source module and the reflection section are mounted on the light-source mounting face of the illuminating device shown in FIG. 2;

FIG. 8 is an enlarged front view showing the main section of a connector for use in the illuminating device shown in FIG. 2;

FIG. 9 is a block diagram showing a drive circuit section for use in the illuminating device according to Embodiment 2 of the present invention;

FIG. 10 is a circuit diagram showing the drive circuit section shown in FIG. 9;

FIG. 11 is a front view showing the main section of an illuminating device according to Embodiment 3 of the present invention;

FIG. 12 A is a view illustrating a radiating section for use in the illuminating device shown in FIG. 11,

FIG. 12 B is a view illustrating the radiating section for use in the illuminating device shown in FIG. 11,

FIG. 12 C is a view illustrating the radiating section for use in the illuminating device shown in FIG. 11,

FIG. 13 is a perspective view showing the configuration of the main section of an illuminating device according to Embodiment 4 of the present invention;

FIG. 14 is an exploded perspective view showing the configuration of the main section of the illuminating device according to Embodiment 4 of the present invention;

FIG. 15 is a sectional view showing the configuration of the main section of the illuminating device according to Embodiment 4 of the present invention;

FIG. 16 is a half-sectional view sectional view showing the configuration of the main section of the radiating member according to Embodiment 4 of the present invention;

FIG. 17A is a top view showing the configuration of the main section of the illuminating device and an enlarged view showing the main section of a groove according to Embodiment 4 of the present invention;

FIG. 17B is a top view showing the configuration of the main section of the illuminating device and an enlarged view showing the main section of the groove according to Embodiment 4 of the present invention;

FIG. 18 is a top view showing the main section of a reflection plate in the illuminating device according to Embodiment 4 of the present invention;

FIG. 19 is a front view showing the configuration of the main section of an illuminating device according to Embodiment 5 of the present invention;

FIG. 20A is a sectional view showing the configuration of the main section of the illuminating device and a view illustrating the main section according to Embodiment 5 of the present invention;

FIG. 20B is a sectional view showing the configuration of the main section of the illuminating device and a view illustrating the main section according to Embodiment 5 of the present invention;

FIG. 20C is a sectional view showing the configuration of the main section of the illuminating device and a view illustrating the main section according to Embodiment 5 of the present invention; and

### DETAILED DESCRIPTION

A connector for connecting a radiating section to a cap and an illuminating device equipped with the connector according to embodiments of the present invention will be described below using the drawings. Although illuminating devices having LEDs serving as light sources are exemplified in the descriptions of the following embodiments, the light source is not limited to LEDs but may be other semiconductor light-emitting devices, such as EL (electroluminescence).

### Embodiment 1

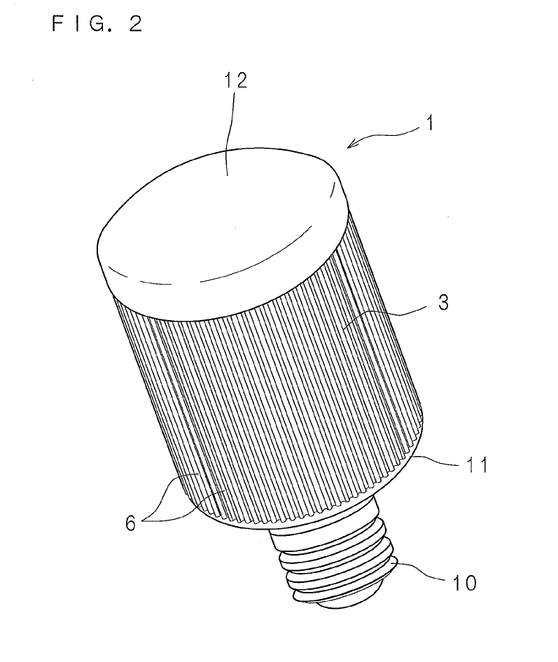

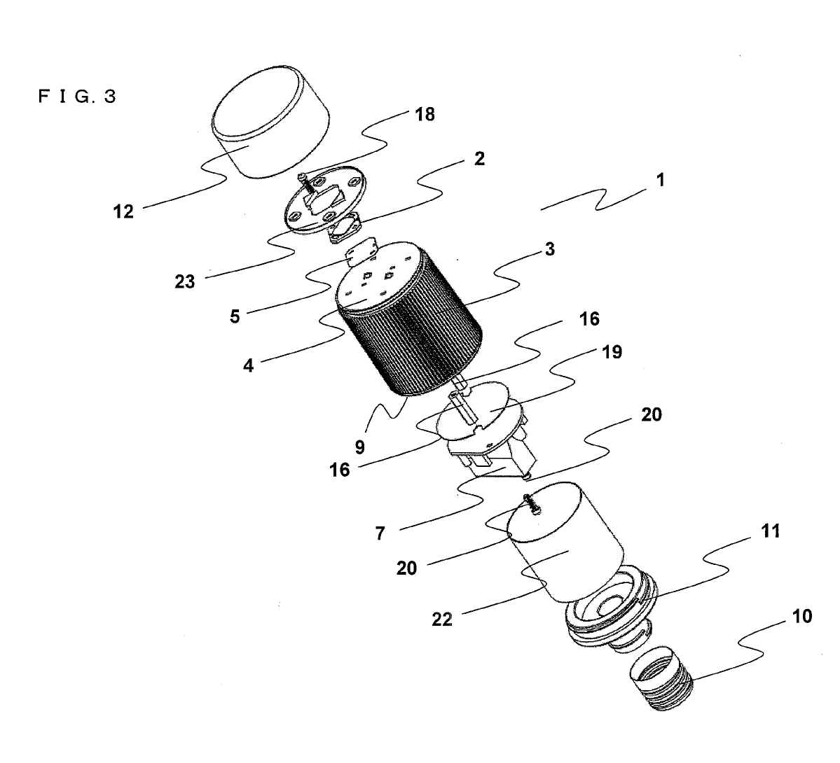

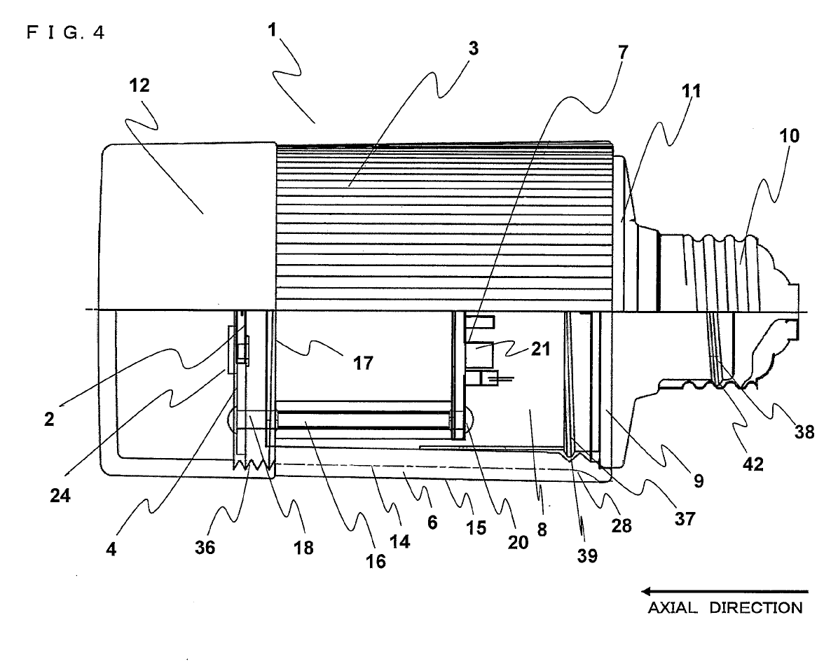

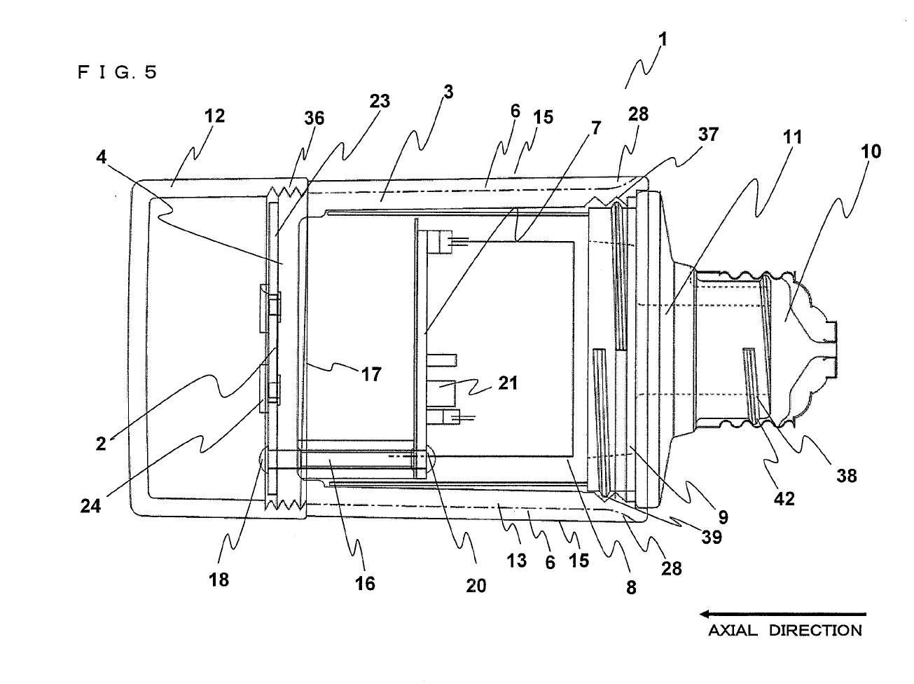

FIG. 2 is a perspective view showing the main section of an illuminating device according to Embodiment 1 of the present invention. FIG. 3 is an exploded perspective view showing the main section of the illuminating device shown in FIG. 2. FIG. 4 is a vertical half-sectional view showing the main section of the illuminating device shown in FIG. 2. FIG. 5 is a vertical sectional view showing the main section of the illuminating device shown in FIG. 2.

First, the configuration of an illuminating device 1 will be described referring to FIGS. 2 to 5. The illuminating device 1 is an LED bulb in which a light source module 2 having a plurality of LEDs (not shown) serves as a light source, and the above-mentioned light source module 2 is mounted on the light-source mounting face 4 of a radiating section 3 via a heat conductive sheet 5. The radiating section 3 is made of a metal being light in weight and high in thermal conductivity, such as aluminum, and has a nearly cylindrical shape. In addition, the radiating section 3 has a plurality of radiating grooves 6 on the outer circumferential face of the cylinder, and the heat transferred from the light source module 2 to the radiating section 3 is radiated from the outer circumferential face to the outside air using the radiating grooves 6.

Furthermore, a cavity is formed inside the radiating section 3 and has an accommodation section 8 for accommodating a drive circuit section 7 for driving the above-mentioned light source module 2. Moreover, on the side of the opening end 9 of the accommodation section 8 of the radiating section 3, a cap 10 that is fitted into an external socket so as to serve as a power source connection section for electrical connection to a commercial power source is provided, and the cap 10 is connected to the radiating section 3 via a connector 11.

The drive circuit section 7 is formed of a plurality of electronic circuit components 21, such as a protecting circuit, a rectifying circuit and a constant current circuit, and the alternating current supplied from the commercial power source is converted into a constant current using the drive circuit section 7 and supplied to the light source module 2.

Besides, the radiating section 3 has a translucent section 12 serving as a light-controlling member for controlling the light emitted from the light source module 2 so as to control light distribution, etc. on an irradiated face and also serving as a cover, and the translucent section 12 is screw-engaged with the end section of the outer circumferential face 15 of the radiating section 3 on the side of the light-source mounting face 4. The translucent section 12 is made of a milky-white polycarbonate resin.

Next, the structure of the radiating section 3 will be described in detail. The radiating section 3 has the plurality of radiating grooves 6 formed in parallel with the axial direction of the cylinder (in the arrow-indicated direction shown in FIGS. 4 and 5), each groove being a straight groove extending in one direction from one end to the other end of the cylinder. Since the convex sections 13 formed among the plurality of radiating grooves 6 are each formed into a smoothly rounded shape without edges, when the user touches the radiating section 3 in the case of replacing the bulb, for example, the user is prevented from being injured.

Still further, the depth of the radiating groove 6 is obtained, depending on the relationship to the outside diameter of the cylinder of the radiating section 3 and the number of the radiating grooves 6, from the surface area (hereafter referred to as a radiating area) required to securely obtain heat radiation performance for sufficiently radiating the heat generated from the light source module 2 and/or the drive circuit section 7 serving as heat sources using the radiating section 3. In the radiating section 3 according to this embodiment, the outside diameter of the cylinder is approximately 68 mm and the length of the cylinder is approximately 109 mm; in the case that the number of the radiating grooves 6 is 90, the width of the radiating groove 6 is approximately 1.5 mm and the depth thereof is approximately 1.5 mm. The size of the bulb corresponds to that of type 20. The radiating area required to sufficiently radiating the heat generated from the light source module 2 will be described later by showing experimental results.

Since the depth of the above-mentioned radiating groove 6, approximately 1.5 mm, is very shallow in comparison with the depth among the radiating fins provided on the conventional LED bulb, dust hardly accumulates in the radiating grooves 6; even if dust accumulates in the radiating grooves 6, cleaning can be carried out easily. As a result, since the radiating section 3 can be maintained clean at all times, ignition due to dust can be prevented, and the safety of the illuminating device can be enhanced. According to the experiments conducted by the inventors, in the case that the depth of the radiating groove 6 is approximately 2 mm or less, it is confirmed that the cleaning performance thereof is excellent. Furthermore, it is preferable that the bottom section 14 of the radiating groove 6 should be formed so as to become gradually shallower with respect to the outer circumferential face 15 of the radiating section, for example, such that the corner section 28 at least one end of the radiating groove 6 is formed into a rounded shape. Hence, even if dust is very fine, such dust can be swept out easily with a cleaning tool, such as a brush, by taking advantage of the structure in which the above-mentioned radiating groove 6 is formed so as to become gradually shallower.

Moreover, the direction in which the radiating grooves 6 are provided is not limited to the axial direction but may be a direction along the circumference of the cylinder. Besides, in the case that the radiating grooves 6 are provided in one direction, dust can be swept out by moving a cleaning tool, such as a brush, in the one direction, whereby the cleaning performance thereof is improved.

It has been found that the temperature of the radiating section 3 rises by 4 C° to 5 C° due to dust accumulation on the radiating section 3 according to the experiments conducted by the inventors; hence, the heat radiation performance of the radiating section 3 can also be improved by forming a structure in which dust hardly accumulates. Still further, since the service life of the semiconductor light-emitting device, such as an LED, becomes short due to heat, the temperature of the LEDs of the light source module 2 can be lowered by improving the heat radiation performance of the radiating section 3, and this can contribute to the long service life of the light source module 2.

In addition, it is preferable that the diameter of the outer circumference of the radiating section 3 should be reduced slightly at an inclination angle of approximately 1° in a direction from the side of the cap 10 to the side of the light-source mounting face 4. By virtue of the slight reduction in the diameter of the radiating section 3, in the case that the radiating section 3 is produced by die-cast metal mold casting, the process of extracting it from the metal mold can be carried out easily, and productivity can be improved.

Furthermore, it is preferable that the light-source mounting face 4, the outer circumferential face 15 and the radiating grooves 6, serving as the surfaces of the radiating section 3, should be painted. Since the painting can delay the progression of oxidation, such as rust, and corrosion, the durability of the illuminating device can be enhanced. Besides, white painting is further preferable. In comparison with the other colors, white can enhance the heat radiation performance of the radiating section 3.

Next, the structure for supporting the drive circuit section 7 in the accommodation section 8 of the radiating section 3 will be described in detail.

The accommodation section 8, a cavity, having a volume required to accommodate the drive circuit section 7 is formed inside the radiating section 3 as shown in FIGS. 4 and 5. The drive circuit section 7 is supported so that a predetermined distance is maintained from the bottom face 17 of the accommodation section 8 using two columnar spacers 16. One end of the spacer 16 is connected and secured to a first engaging section 18, such as a screw, provided so as to pass through the bottom face 17 of the accommodation section 8 and the light-source mounting face 4, and the other end of the spacer 16 is connected and secured to a second engaging section 20, such as a screw, via an insulation sheet 19 placed on the circuit board of the drive circuit section 7.

Hence, the drive circuit section 7 is mechanically secured to the bottom face 17 of the accommodation section 8 via the spacers 16, whereby the drive circuit section 7 can be supported stably inside the accommodation section 8 even in the case that the illuminating device is subjected to shock from the outside.

In addition, it is preferable that the drive circuit section 7 is supported inside the accommodation section 8 so that the electronic circuit components 21 constituting the drive circuit section 7 are disposed on the side of the cap 10. As a result, since the light source module 2 and the drive circuit section 7 serving as heat sources can be supported while a constant distance is provided therebetween, the concentration of the heat sources can be avoided, the risk of ignition can be reduced, and the heat radiation performance of the radiating section 3 can be improved.

Since the spacers 16 are required to ensure electrical insulation between the bottom face 17 of the radiating section 3 and the drive circuit section 7, it is preferable that the spacers are made of a material having electrical insulation properties, for example, a synthetic resin, such as PBT (polybutylene terephthalate).

Furthermore, since the drive circuit section 7 is supported so that the predetermined distance is maintained from the bottom face 17 of the accommodation section 8 of the radiating section 3 while the insulation sheet 19 is disposed therebetween, electrical insulation properties can be ensured between the radiating section 3 and the drive circuit section 7. Moreover, the electrical insulation between the radiating section 3 and the drive circuit section 7 is attained more securely by providing the insulation sheet 19 so as to enclose the drive circuit section 7 on the inner circumferential face of the accommodation section 8.

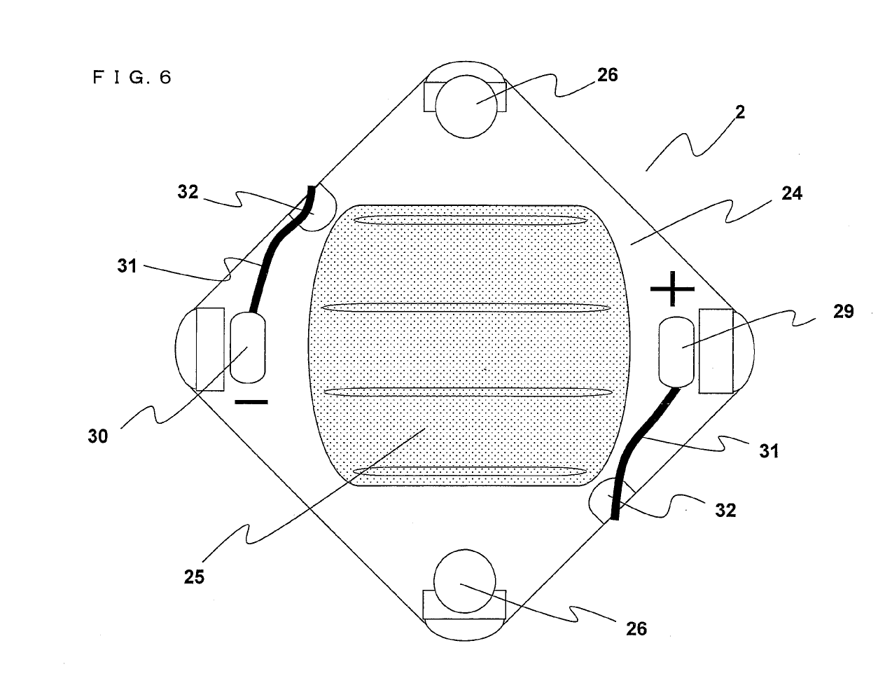

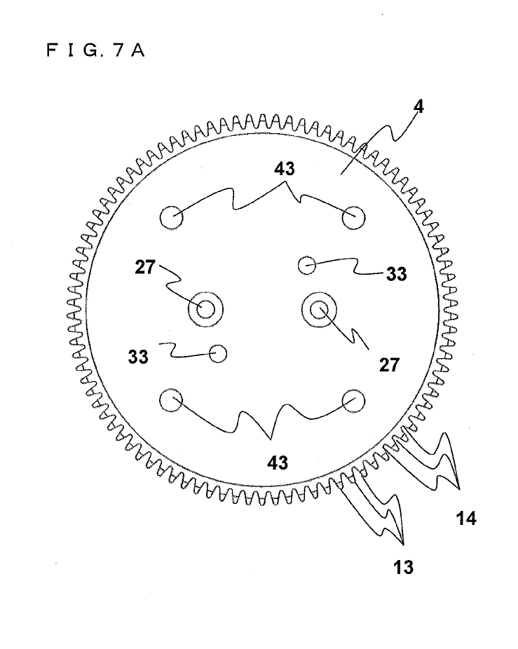

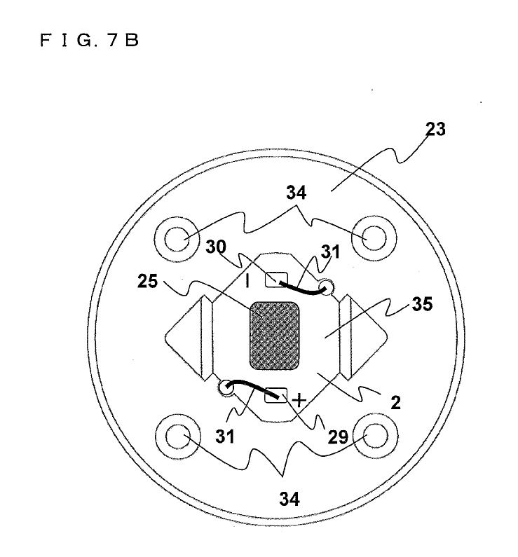

Next, the light source module 2 and the structure for securing the light source module 2 onto the light-source mounting face 4 will be described in detail. FIG. 6 is a schematic view showing the light source module 2. FIGS. 7A and 7B are views illustrating the mounting states of the light source module 2 and a reflection section 23 on the light-source mounting face 4; FIG. 7A shows the light-source mounting face 4 being in a state in which the light source module 2 and the reflection section 23 are not mounted, and FIG. 7B shows the state of the light-source mounting face 4 being in a state in which the light source module 2 and the reflection section 23 are mounted (however, the radiating section is omitted).

The light source module 2 is a pseudo-white light source module in which a plurality of LED chips (not shown) are densely mounted on a module substrate 24 having an approximately rectangular shape and made of ceramic, and the plurality of LED chips are sealed with a sealing resin containing a phosphor. Since the phosphor is excited by the blue light emitted from the LED chips and generates yellow light, the light emitted from the light source module 2 is visually recognized as white due to the blue light from the LED chips and the yellow light from the phosphor.

In addition, two light source module engaging holes 26 are provided at the end sections located at the opposing corners of the rectangular module substrate 24, and the light source module 2 is positioned on the light-source mounting face 4 by fitting the light source module engaging holes 26 onto the positioning convex sections 27 provided on the light-source mounting face 4. Since the heat conductive sheet 5 is disposed between the light source module 2 and the light-source mounting face 4 as described above, the heat from the light source module 2 can be transferred efficiently to the radiating section 3.

Furthermore, a pair of electrodes for inputting the constant current supplied from the drive circuit section 7 is formed at the end sections located at the opposing corners of the rectangular module substrate 24 in which the light source module engaging holes 26 are not provided. One of the electrodes is a positive electrode 29 and the other is a negative electrode 30. Wires 31 for supplying a current to the light source module 2 are connected to the positive electrode 29 and the negative electrode 30; the wires 31 pass through the notches 32 formed on two opposing sides of the rectangular module substrate 24; furthermore, the wires are inserted into the wiring insertion holes 33 formed in the light-source mounting face 4 of the radiating section 3 and are connected to the drive circuit section 7.

The plate-like reflection section 23 for supporting the light source module 2 by pressing it from the irradiated side and for reflecting the light emitted from the light source module 2 and the light irregularly reflected by the translucent section 12 are mounted on the light-source mounting face 4.

The reflection section 23 has four reflection section engaging holes 34, and the spacers 16 for supporting the drive circuit section 7, the light source module 2 and the reflection section 23 can be secured integrally by engaging the above-mentioned first engaging sections 18 using the engaging holes 43 of the light-source mounting face 4 from the irradiated side at two of the reflection section engaging holes 34. Since the reflection section 23 is used to secure both the spacers 16 and the light source module 2, members for engaging individual components, such as screws for securing the light source module 2, are not necessary, whereby the number of components can be reduced.

Besides, a rectangular light extracting window 35 through which the light from the light source module 2 is extracted is provided at a position corresponding to the light source module 2 located at the center of the reflection section 23. The light extracting window 35 has a shape corresponding to that of the light-emitting section 25 of the light source module 2, and inclined faces are formed around the circumference of the light extracting window 35, whereby light can be reflected effectively.

Still further, the outer circumference of the reflection section 23 and the circumferences of the positions corresponding to the reflection section engaging holes 34 and the positioning convex sections 27 of the light-source mounting face 4 are formed into a rib shape to ensure the strength of the reflection section 23.

It is preferable that the reflection section 23 has high reflectivity (approximately 95%), and the reflection section is colored white to improve its reflectivity. In addition, since the reflection section supports the light source module 2 serving as a heat source by pressing it, it is preferable that the reflection section 23 is made of a flame-retardant material. In this embodiment, a polycarbonate resin is used.

Next, the translucent section 12 and the structure for mounting the translucent section 12 on the radiating section 3 will be described in detail. The translucent section 12 is a cylindrical cover made of a polycarbonate resin; the length of the cylinder in the axial direction is approximately 30 mm, the thickness thereof is approximately 3 mm, the total light transmittance thereof is approximately 55%, and the dispersion ratio thereof is approximately 60%. In addition, the central neighborhoods of the top face and the inner top face of the cylinder are swollen slightly approximately 0.5 mm and approximately 1 mm, respectively, and the diameter of the outer circumferential face of the translucent section 12 is reduced at an inclination angle of approximately 1° as the diameter of the radiating section 3 is reduced. With the above-mentioned shape, the translucent section 12 formed into a cylindrical shape can have a slightly rounded shape and has a shape along the radiating section 3, whereby the appearances of the translucent section 12 and the bulb can be improved. Furthermore, since the shape is significantly different from that of the conventional bulb having a rounded shape, a fresh image can be provided for the user.

Besides, the translucent section 12 is screw-engaged with the end section of the radiating section 3 on the side of the light-source mounting face 4; a third screw-engaging structure 36 is made by forming a female thread (concave section) on the side of the translucent section 12 and by forming a male thread (convex section) on the side of the radiating section 3.

By virtue of a configuration in which the translucent section 12 can be replaced with plural kinds of translucent sections being different in optical characteristics, such as light distribution characteristics, and in color, the user can select a translucent section depending on, for example, the location in which the illuminating device is installed, whereby the versatility of the illuminating device can be improved.

Next, the connector 11, the screw-engaging structure of the connector 11 and the radiating section 3 and the screw-engaging structure of the connector 11 and the cap 10 will be described in detail. The connector 11 has an insertion passage (not shown) for allowing the wires for electrically connecting the drive circuit section 7 to the cap 10 to pass through, and both the end sections of the connector 11 have cylindrical shapes matched to the shapes of the accommodation section 8 of the radiating section 3 and the cap 10. Since the radiating section 3 is made of a metal to radiate the heat from the heat sources as described above and thus has conductivity, it is necessary that electrical insulation properties are provided between the cap 10 electrically connected to the commercial power source and the radiating section 3 serving as a conductive member. In addition, the connector 11 has heat resistance so as to be prevented from being melted, for example, and deformed due to the heat transferred from the heat sources. The connector 11 according to this embodiment is made of porcelain.

Furthermore, since porcelain has electrical insulation properties and has a melting point of approximately 1200° C., higher than that of a synthetic resin (for example, the melting point of plastic is approximately 100° C. to 200° C.) being used for the connector of the conventional bulb, porcelain has high heat resistance. Moreover, since porcelain has heat conductivity higher than that of a synthetic resin (for example, approximately 10 times higher than that of plastic), the connector 11 can serve as a radiator.

In the case that the connector 11 has non-combustibility without considering its heat resistance, even if the drive circuit section 7 inside the accommodation section 8 is ignited, the connector 11 itself can be prevented from being ignited. Hence, it may be possible to use materials other than porcelain, such as glass and PBT (polybutylene terephthalate).

Still further, in order to connect the radiating section 3 to the cap 10, the connector 11 has a first screw-engaging structure 37, disposed between the connector 11 and the radiating section 3, for screw-engaging the connector 11 with the radiating section 3, and has a second screw-engaging structure 38, disposed between the connector and the cap 10, for screw-engaging the connector with the cap 10.

The first screw-engaging structure 37 is formed of a first connector mounting concave section 39 serving as a female thread (concave section) formed at the end section of the inner circumferential face of the accommodation section 8 on the opening end side thereof and a radiating section mounting convex section 40 serving as a male thread (convex section) formed at the end section of the outer circumferential face of the connector 11 on the side of the radiating section 3. The connector 11 can be screw-engaged with the radiating section 3 by screw-engaging the radiating section mounting convex section 40 with the first connector mounting concave section 39.

The second screw-engaging structure 38 has a cap mounting convex section 41 serving as a male thread (convex section) formed at the end section of the outer circumferential face of the connector 11 on the side of the cap 10 and a second connector mounting concave section 42 serving as a female thread (concave section) that is screw-engaged with the cap mounting convex section 41 formed at the end section of the inner circumferential face of the cap 10 on the side of the connector 11. The connector 11 can be screw-engaged with the cap 10 by screw-engaging the cap mounting convex section 41 with the second connector mounting concave section 42.

Since the molding accuracy of porcelain is lower than that of a synthetic resin such as plastic, it is preferable that the following features are provided in the case that the radiating section mounting convex section 40 and the cap mounting convex section 41 are formed on the connector 11.

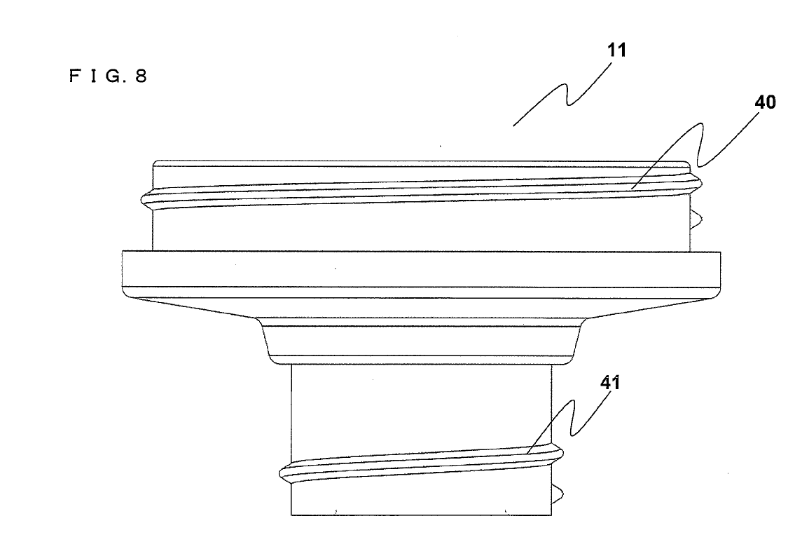

FIG. 8 is an enlarged front view showing the main section of the connector 11 according to Embodiment 1. Referring to FIG. 8, the features of the radiating section mounting convex section 40 and the cap mounting convex section 41 formed on the connector 11 will be described. First, since it is difficult to provide a female thread, which is more difficult to be molded than a male thread, on porcelain being low in molding accuracy, the radiating section mounting convex section 40 and the cap mounting convex section 41 corresponding to male threads are molded on the side of the connector 11 in the screw-engaging structures at both end sections of the connector 11.

Furthermore, the convex shapes of the radiating section mounting convex section 40 and the cap mounting convex section 41 have a rounded shape, whereby the rounded shape is made more difficult to be cracked than an angular shape. The screw engagement can be carried out firmly by setting the heights of the convex sections of the radiating section mounting convex section 40 and the cap mounting convex section 41 to approximately 1 mm or more.

Moreover, for the purpose of improving the production yield of the connector 11, it is preferable that the thickness of the connector 11 should be approximately 3 mm or more and that the radiating section mounting convex section 40 and the cap mounting convex section 41 are formed away from the end sections of the connector 11 by approximately 0.5 mm or more. Still further, it is preferable that the radiating section mounting convex section 40 and the cap mounting convex section 41 are molded by one round or less on the outer circumferential face of the connector 11.

In addition, for the purpose of ensuring the drip-proofness of the accommodation section 8 for accommodating the drive circuit section 7, it is preferable that the screw engagement between the radiating section 3 and the connector 11 and the screw engagement between the connector 11 and the cap 10 should be provided with hermetic sealing. Hence, it is preferable that a sealing agent serving as a sealing material should be disposed between the first connector mounting concave section 39 and the radiating section mounting convex section 40 constituting the first screw-engaging structure 37 and between the second connector mounting concave section 42 and the cap mounting convex section 41 constituting the second screw-engaging structure 38. As a result, screw engagement can be carried out while hermetic sealing is provided.

A sealing agent having a property of sticking and adhering while being elastic, instead of having a property of complete adhering, is preferable as the sealing agent. For example, even if the drive circuit section 7 inside the accommodation section 8 fails and cannot provide illumination, the individual components thereof can be disassembled.

In addition, it is preferable that a protective agent, such as glaze, should be applied to the outer circumferential face of the connector 11, more particularly, to the central neighborhood of the outer circumferential face that is exposed in the case that the radiating section 3, the connector 11 and the cap 10 are connected. By the application of glaze, the unevenness on the surface of the porcelain constituting the connector 11 can be smoothed.

Since the radiating section 3, the connector 11, the cap 10 and the translucent section 12 are respectively screw-engaged as described above, they can be disassembled easily. Hence, even if any of the above-mentioned components fails, it can be replaced easily, whereby maintainability can be improved.

At the end, the results of an experiment conducted with respect to a radiating area required to sufficiently radiate the heat generated from the light source module 2 will be described. The experiment was conducted under the conditions that a plurality of LED chips were mounted and that a light source module having a thickness of 1 mm and an amount of heat generation of 8.65×10⁶ W/m³ was secured to the front side of a rectangular aluminum substrate while a heat conductive sheet (having a heat conductivity of 5.0 W/m·K) having a thickness of 1 mm was held therebetween. Furthermore, the above-mentioned aluminum substrate having a heat conductivity of 237 W/m·K, a thickness of 1 mm and an area of 112×112 mm was cooled only by air using the outside air (having a heat conductivity of 5.8 W/m²·K). The above-mentioned air cooling was carried out only on the rear side of the above-mentioned aluminum substrate.

As a result of simulation conducted under the above-mentioned conditions, it is found that a radiating area, i.e., the rear area of the above-mentioned aluminum substrate, of 12500 mm² is required in the case of type 20 illuminating device, a radiating area of 25000 mm² is required in the case of type 40 illuminating device and a radiating area of 37500 mm² is required in the case of type 60 illuminating device. In other words, in order that the radiating section suppresses the temperature rising of 40° C. or more by carrying out air cooling using the outside air, the area of the radiating section and the accommodation section making contact with the outside air and being air-cooled is required to be 12500 mm² in the case of type 20, 37500 mm² in the case of type 40 and 37500 mm² in the case of type 60. However, in actual use, under the consideration that air cooling is not carried out for a flat plane but carried out for the radiating grooves radially provided in parallel on the radiating section and that the accommodation section is hermitically sealed, it is desirable that the radiating area should be approximately 20000 mm² that is 60% larger than 12500 mm² in the case of type 20, for example.

### Embodiment 2

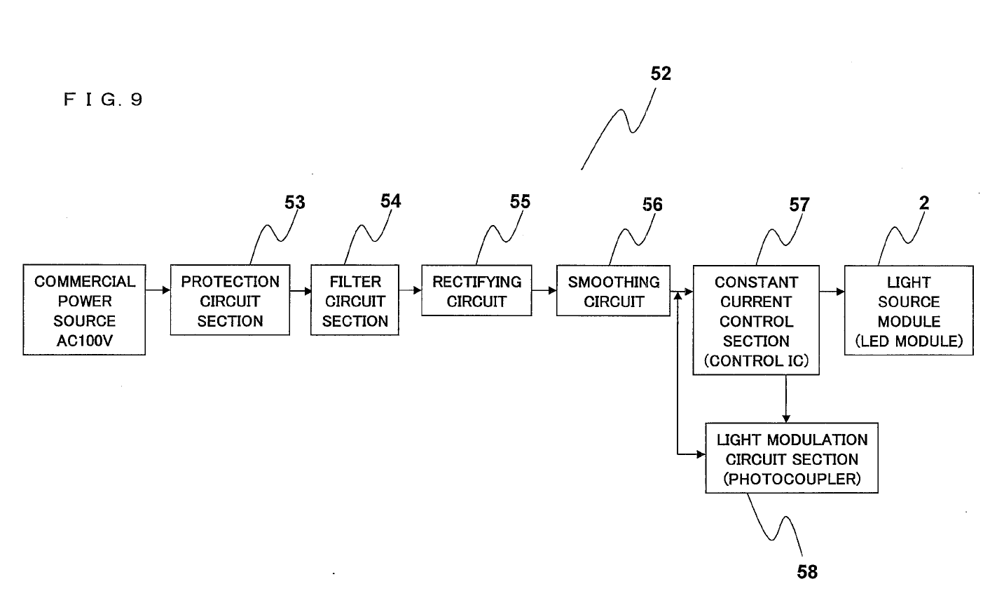

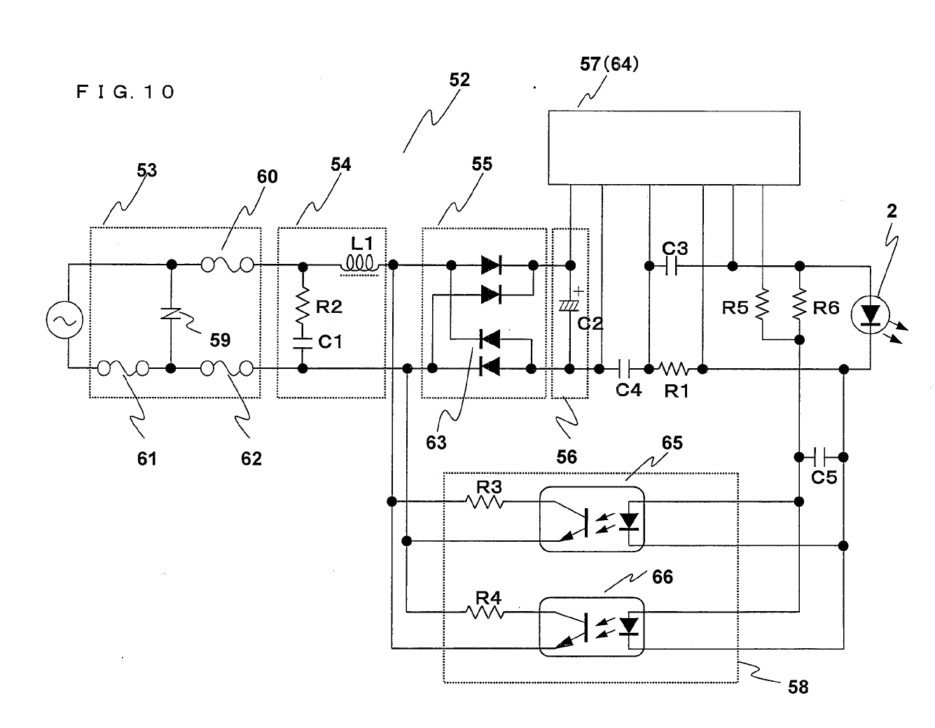

Next, an illuminating device according to Embodiment 2 of the present invention will be described. FIG. 9 is a block diagram showing a drive circuit section 52 for use in the illuminating device according to Embodiment 2. FIG. 10 is a circuit diagram showing the drive circuit section 52 shown in FIG. 9. The illuminating device according to Embodiment 2 is different from the illuminating device according to Embodiment 1 in that the illuminating device is equipped with a protection circuit section for protecting LEDs (light source module 2) serving as a light source in the case that an overcurrent or the like occurs inside the drive circuit section 52 and a light modulation circuit section for modulating the light of the light source module 2. Since the other components of the illuminating device are the same as those according to Embodiment 1, they are designated by the same codes and their detailed descriptions are omitted.

The configuration of the drive circuit section 52 will be described using FIG. 9. The drive circuit section 52 is electrically connected to the commercial power source via the cap 10 and wires distributed from the cap 10, and the commercial power source is first connected to the protection circuit section 53. The protection circuit section 53 is formed of power fuses (a first power fuse 60 and a second power fuse 61) that are cut off if an overcurrent exceeding the rated current flows to protect the drive circuit section 52 (in particular, a control IC 64) and the light source module 2; a thermal fuse 62 that is cut off if the atmospheric temperature around the drive circuit section 52 becomes a predetermined temperature or higher to protect the drive circuit section 52 (in particular, the control IC 64) and the light source module 2; and a varistor 59 for protecting the drive circuit section 52 (in particular, the control IC 64) and the light source module 2 against an overvoltage.

The output terminals of the protection circuit section 53 are connected to a filter circuit section 54. The filter circuit section 54 is formed of a capacitor C1, a resistor R2 and a choke coil L1. The filter circuit section 54 eliminates noise contained in the alternating current supplied from the commercial power source.

The output terminals of the filter circuit section 54 are connected to a rectifying circuit 55. The rectifying circuit 55 is a diode bridge 63 formed of four diodes wherein the supplied alternating current is subjected to full-wave rectification and then output.

The output terminals of the rectifying circuit 55 are connected to a smoothing circuit 56. The smoothing circuit 56 is formed of a smoothing capacitor wherein the current subjected to the full-wave rectification in the rectifying circuit 55 is smoothed to a direct current. As the smoothing capacitor C2, a large-capacity electrolytic capacitor is used for example.

The output terminals of the smoothing circuit 56 are connected to a constant current control section 57. The constant current control section 57 is formed of the control IC wherein the direct current input from the smoothing circuit 56 is controlled and a constant current is supplied to the light source module 2 formed of a plurality of LEDs. The constant current control section 57 incorporates a transformer serving as a voltage lowering circuit to lower the voltage thereof to the level of the drive voltage of the light source module 2.

Furthermore, one of the output terminals of the constant current control section 57 is connected to the input terminal of the light source module 2, and the other output terminal of the constant current control section 57 is connected to a light modulation circuit section 58. The light modulation circuit section 58 is formed of photocouplers wherein a light modulation signal is transmitted.

The connection relationship among the respective electronic circuit components will be described in more detail using FIG. 10. The varistor 59 is connected in parallel with the commercial power source for supplying an alternating current, the first power fuse 60 is connected to one terminal of the commercial power source, and the second power fuse 61 and the thermal fuse 62 are connected to the other terminal thereof.

Next, the series connection of the resistor R2 and the capacitor C1 is connected in parallel with the output terminals of the protection circuit section 53, and the choke coil L1 is connected to the output terminal of the first power fuse 60.

Furthermore, the diode bridge 63 and the smoothing circuit C2 are connected sequentially in parallel, and one terminal of the smoothing circuit C2 is connected to the control IC 64 serving as the constant current control section 57. One output terminal of the control IC 64 is connected to the light source module 2 formed of a plurality of LEDs, and another output terminal thereof is connected to a first photocoupler 65 and a second photocoupler 66 serving as the light modulation circuit section 58.

In the case that light modulation control is carried out, the light modulation signal output from the first photocoupler 65 is input to the control IC 64, and the control IC 64 supplies a light-modulated current to the light source module 2 depending on the light modulation signal, whereby the light modulation control is carried out. More specifically, a phase control section (not shown) is provided on the power input side of the drive circuit section 52, and the phase control section performs phase control for the alternating current supplied from the commercial power source and outputs a power waveform for carrying out light modulation. Next, the first photocoupler 65 transmits the light modulation signal to the control IC 64 in response to the above-mentioned power waveform, and the control IC 64 performs output control (PWM control) depending on the above-mentioned light modulation signal, whereby the light source module 2 is subjected to light modulation.

With the above-mentioned configuration, the alternating current supplied from the commercial power source is converted into a constant current and input to the light source module 2, and the light source module 2 emits light at a predetermined brightness. Furthermore, light emission can be performed while the brightness is switched to different levels by controlling the light modulation circuit section 58. A configuration in which the brightness of the light source module 2 is changed can be attained by inputting a light modulation switching signal from the outside to the constant current control section 57.

In addition, since the illuminating device is equipped with the light modulation function as described above, the user can carry out light modulation as desired and can control the brightness of the light source depending on the location in which the illuminating device is installed and depending on time and use.

Furthermore, the circuit configuration of the above-mentioned drive circuit section 52 is taken as an example, and the configuration of each circuit section thereof is not limited particularly. For example, although the drive circuit section is equipped with the protection circuit formed of the power fuses, the thermal fuse and the varistor, the drive circuit section is not required to have all of the power fuses, the thermal fuse and the varistor but may have only one of them. The illuminating device may have only one of the protection circuit section and the light modulation circuit section.

Since the illuminating device is equipped with the light modulation function, the illuminating device can carry out light modulation control depending on the location in which the illuminating device is installed and depending on use as described above; an example of light modulation control in the case that the illuminating device is installed inside a building wherein domestic animals, such as chickens, are reared will be described herein.

For example, if chickens are frightened by the illumination light inside the building wherein the chickens are reared, there occurs a problem that the number of chicken eggs is reduced. Hence, the chickens can be accustomed to the illumination light by increasing the intensity (brightness) of the illumination light inside the building wherein the chickens are reared to a level higher than an ordinary level in the beginning. When the intensity (brightness) of the illumination light is then lowered gradually, the chickens are less frightened by the illumination light since the chickens are accustomed to the bright illumination light. As a result, it is possible to avoid the problem that the chickens are frightened by the illumination light and the number of chicken eggs is reduced, and it is possible to attain power saving.

Furthermore, even in the case of illumination inside a room used by an ordinary person, illumination can be carried out at a desired brightness by carrying out light modulation depending on the location in which the illuminating device is installed and depending on the use of the illuminating device and the age, etc. of the user. In a location wherein outside light enters, illumination is performed while the intensity (brightness) of the illumination is lowered, whereby power saving can be attained; in the case that the illuminating device is used by an elderly user, the user can read characters easily by increasing the intensity (brightness) of the illumination.

### Embodiment 3

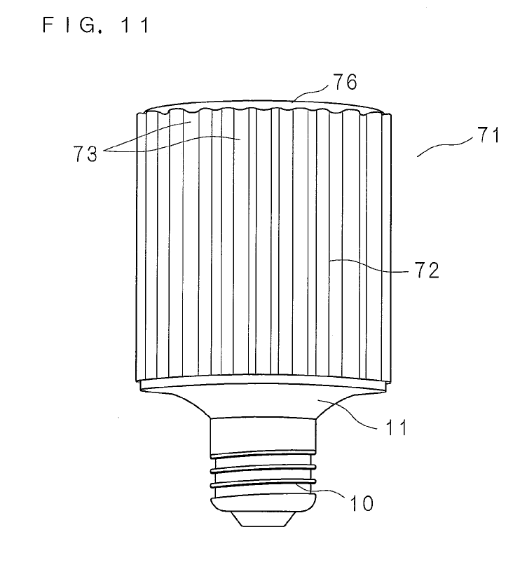

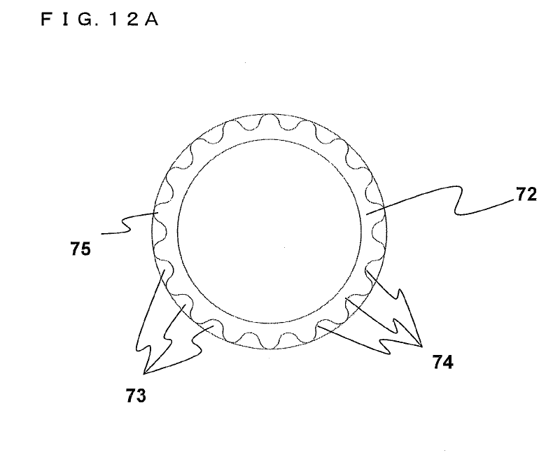

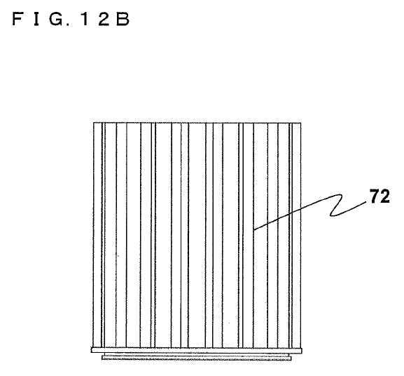

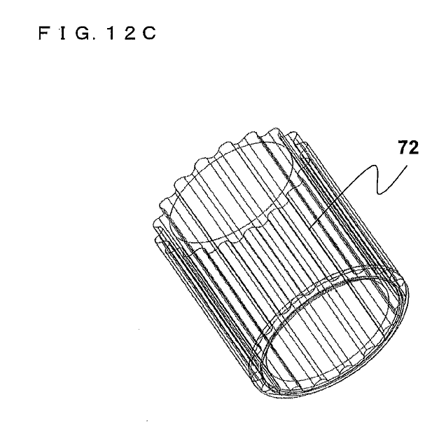

Next, an illuminating device 71 according to Embodiment 3 of the present invention will be described. FIG. 11 is a front view showing the main section of the illuminating device 71. FIGS. 12A to 12C are views illustrating a radiating section 72 for use in the illuminating device 71 shown in FIG. 11; FIG. 12 A is a horizontal sectional view showing the main section of the radiating section 72, FIG. 12 B is a front view showing the main section of the radiating section 72, and FIG. 12 C is a perspective view showing the main section of the radiating section 72. The illuminating device 71 according to Embodiment 3 has a radiating section and a translucent section different from those of the illuminating device according to Embodiment 1 or Embodiment 2; since the other components of the illuminating device are the same as those according to Embodiment 1 or Embodiment 2, they are designated by the same codes and their detailed descriptions are omitted.

Like the radiating section described in Embodiment 1, the radiating section 72 according to this embodiment has a cylindrical shape and is equipped with the accommodation section 8 for accommodating the drive circuit section 7 therein, and the outside diameter and the length of the cylinder are nearly the same. In addition, the number of the radiating grooves 73 formed on the outer circumferential face 75 of the radiating section 72 is 18, and the width and depth of the radiating groove 73 are approximately 5 mm and approximately 8 mm, respectively. Hence, the depth of the radiating groove 73 is deeper and the width thereof is wider than those of the radiating section described in Embodiment 1.

Since the width of the radiating groove 73 is made wider, a cleaning tool, such as a brush, can easily reach every corner of the bottom section 74 of the radiating groove, and the influence of deterioration in the cleaning performance due to the fact that the depth of the radiating groove 73 is made deeper is reduced, whereby sufficient cleaning performance is ensured. Hence, the radiating section 72 can be cleaned easily and the radiating section 72 can be maintained clean, whereby the safety of the illuminating device 71 can be enhanced.

In addition, although the number of the radiating grooves is fewer than that in the radiating section according to Embodiment 1, since the radiating area formed inside the radiating groove is made larger by making the radiating groove deeper in depth and wider in width, the radiating section can, as a whole, securely obtain a sufficient radiating area required to radiate the heat from the light source module 2 and/or the drive circuit section 7.

Furthermore, although a translucent section 76 is a thin dome-shaped cover different from the translucent section according to Embodiment 1, the translucent section is not limited to have this shape but may be a translucent section having a cylindrical shape as in the case of Embodiment 1. By the use of a configuration in width the translucent section can be replaced with plural kinds of translucent sections being different in optical characteristics, such as light distribution, and in color, the user can select a translucent section depending on, for example, the location in which the illuminating device is installed, whereby the versatility of the illuminating device can be improved.

In the above-mentioned embodiments, the connector can connect a conductive member, such as the radiating section, for radiating the heat from a heat source, such as the light source, operating on the supplied power, to a power connection section, such as the cap, connected to the external power source for supplying power to the heat source while maintaining insulation therebetween, and deformation due to the heat from the heat source can be prevented.

Besides, although the connector of the bulb-type illuminating device has been exemplified and described in each of the above-mentioned embodiments, the connector is not limited to this but can also be applied to general illuminating devices, such as miniature bulbs, spot lights and down lights, used for outdoor illumination. Still further, the connector is not limited to be used for illuminating devices but should only be used for electrical devices connected to and driven by an external power source.

### Embodiment 4

It is also possible to provide a radiating member that can be cleaned easily and securely when dust and dirt attach to the grooves thereof for radiating heat from a heat source and to provide a radiating unit equipped with the radiating member and an illuminating device equipped with the radiating member.

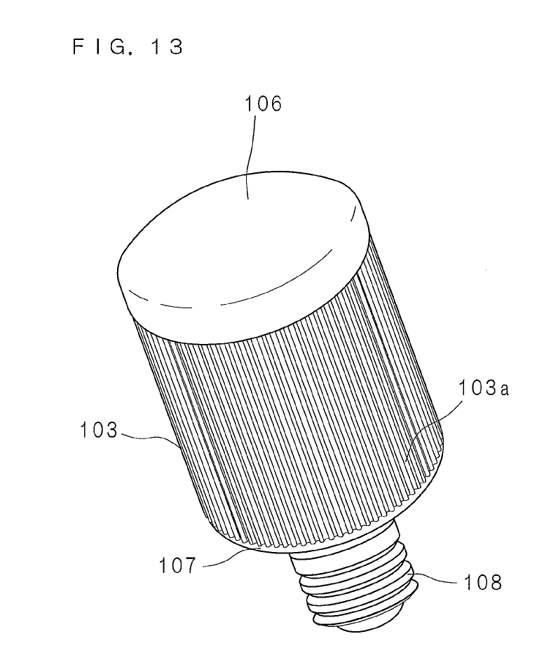

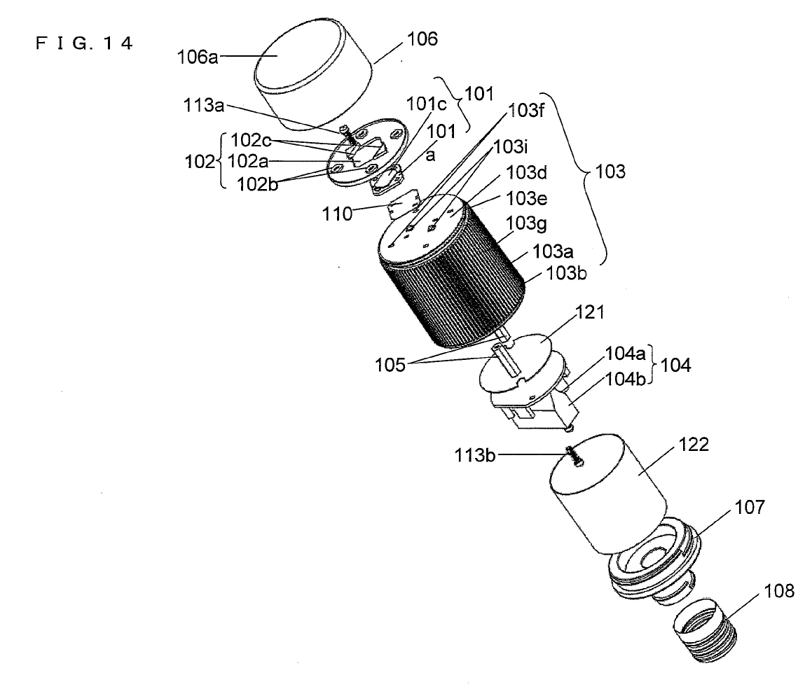

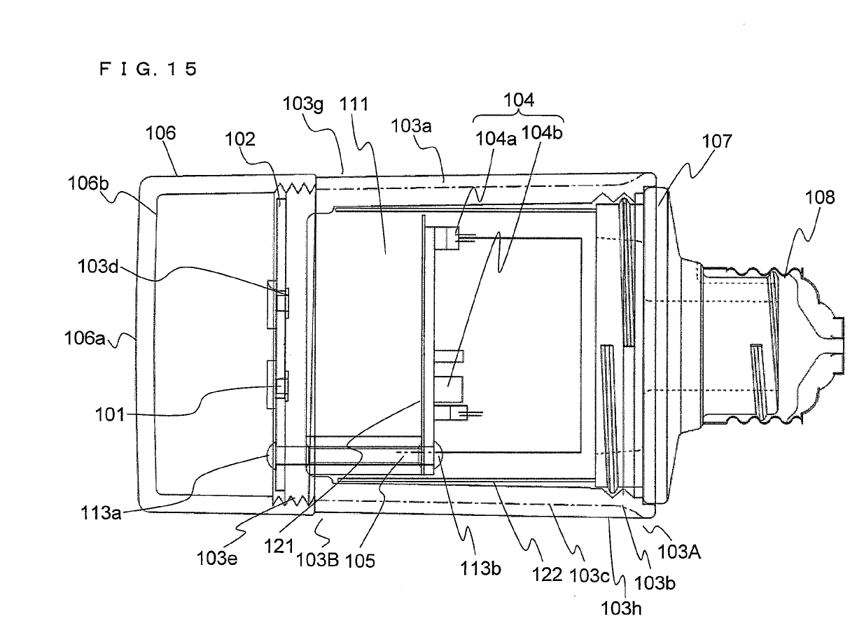

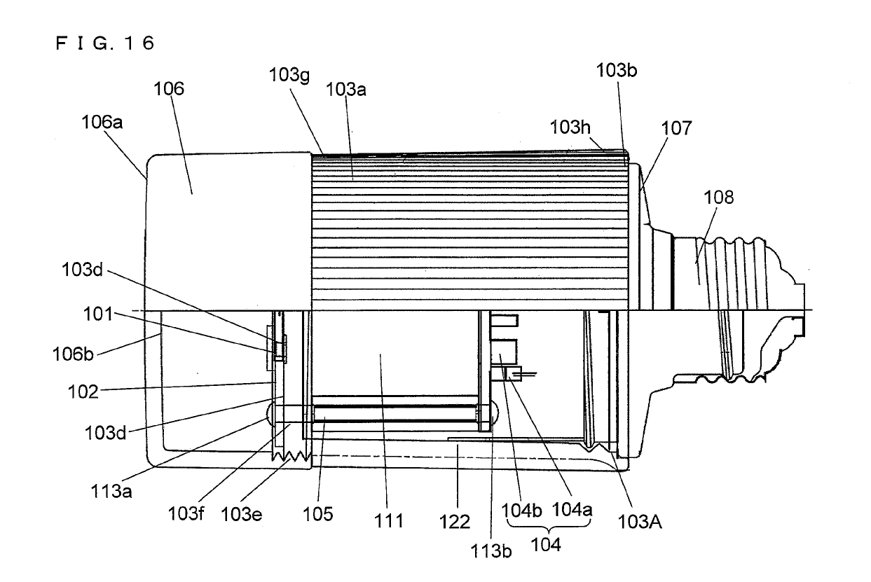

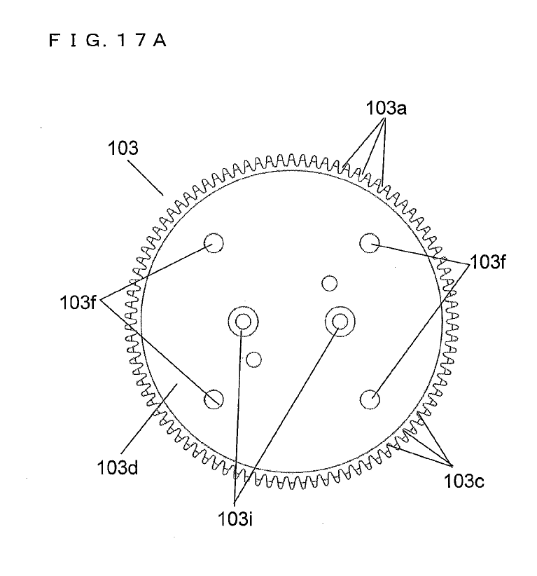

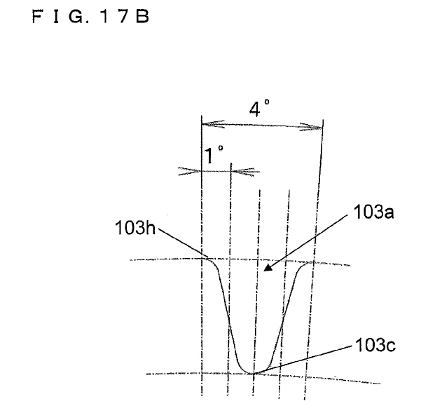

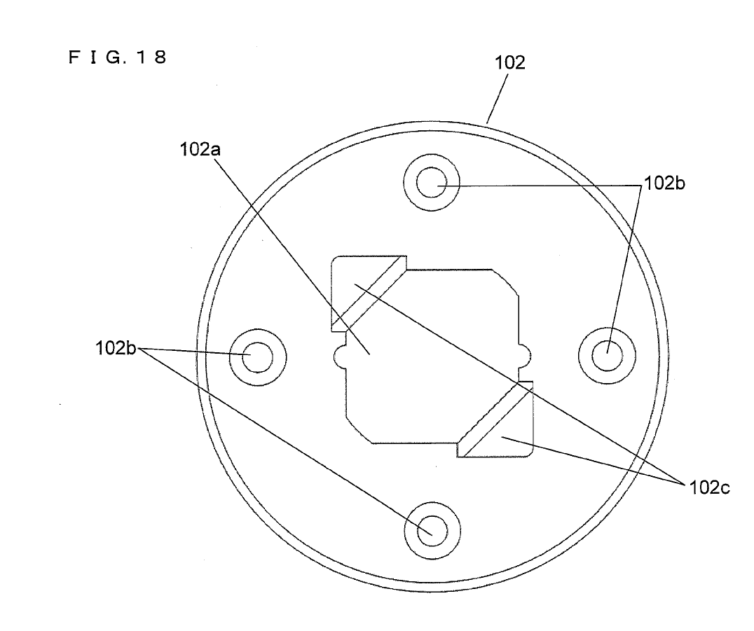

A bulb-type illuminating device (hereafter referred to as an illuminating device) equipped with a radiating member according to Embodiment 4 of the present invention will be described below on the basis of FIGS. 13 to 18. FIG. 13 is a perspective view showing the main section of the illuminating device equipped with the radiating member according to Embodiment 4 of the present invention. FIG. 14 is an exploded perspective view showing the main section of the illuminating device equipped with the radiating member according to Embodiment 4 of the present invention. FIG. 15 is a sectional view showing the main section of the illuminating device equipped with the radiating member according to Embodiment 4 of the present invention. FIG. 16 is a half-sectional view showing the main section of the illuminating device equipped with the radiating member according to Embodiment 4 of the present invention. FIG. 17A is a top view showing the main section of the radiating member according to the present invention, and FIG. 17B is an enlarged view showing the main section of the groove provided in the radiating member according to the present invention. FIG. 18 is a top view showing the main section of a reflection plate. The illuminating device will be described below using the radiating unit formed by the combination of the radiating member and the heat source.

First, the configuration of the illuminating device according to Embodiment 4 of the present invention will be described. The illuminating device is formed of a radiating member 103 having grooves 103a for radiating the heat from an LED module 101, a circuit board 104, etc. serving as heat sources, and a mounting face 103d; the LED module 101 supported on the mounting face 103d of the radiating member 103 via a radiating sheet 110 held therebetween; a reflection plate 102 for holding the LED module 101 on the mounting face 103d; a cover 106 for dispersing the light reflected by the reflection plate 102; the circuit board 104 having a power source circuit 104a and a drive circuit 104b provided so as to be accommodated inside the above-mentioned radiating member 103; a connector 107 screw-engaged with the one end section 103A of the above-mentioned radiating member 103; and a cap 108 screw-engaged with the connector 107.

Next, the configuration of the above-mentioned radiating member 103 will be described. The radiating member 103 has the mounting face 103d having a disc shape and made of a metal being light in weight and high in thermal conductivity, such as aluminum and a main body 103g having a cylindrical shape (hereafter referred to as a cylinder) extending in the circumferential direction around the fringe of the mounting face 103d, and the grooves 103a for securely providing a radiating area are provided linearly on the outer face (or the outer circumferential face) of the main body 103g of the above-mentioned radiating member 103 as shown in FIGS. 13, 14, 16, 17A and 17B in particular.

In addition, the above-mentioned grooves 103a are provided in plural number (in large quantity) linearly, i.e., in parallel with the cleaning direction of the radiating member 103. The above-mentioned cleaning direction is a direction in which the above-mentioned grooves 103a can be cleaned by moving an existing cleaning tool in a constant direction; for example, in the case that the illuminating device according to this embodiment is installed in a bulb socket provided in a direction perpendicular to a horizontal plane, such as a ceiling plane, the direction perpendicular to the horizontal plane is defined as the cleaning direction. Furthermore, the cleaning direction is not limited to this direction but should only be a direction in which cleaning can be carried out by moving an existing cleaning tool in a constant direction; for example, the above-mentioned grooves 103a may be provided in parallel with the direction from the one end section 103A to the other end section 103B of the radiating member 103 described later or in a direction perpendicular thereto.

Although the above-mentioned grooves 103a are provided linearly, they should only be provided in a constant direction in which the cleaning performance can be improved, such as a spiral direction, a zigzag direction, a curved direction or a matrix direction. Furthermore, the area (hereafter referred to as a radiating area) required to securely obtain heat radiation characteristics for sufficiently radiating the heat generated from the heat source using the radiating member 103 is different depending on, for example, the power consumption or brightness of the illuminating device equipped with the radiating member 103; as the above-mentioned power consumption or brightness increases, the amount of heat generation also increases, whereby the radiating area to be required also increases. Hence, the above-mentioned radiating area is obtained according to the relationship between the number of the above-mentioned grooves 103a and the depth thereof depending on the amount of heat generation. In the radiating member 103 according to this embodiment, in the case that the outside diameter of the cylinder is approximately 68 mm and the length of the cylinder is approximately 109 mm, the number of the grooves 103a is 90, the depth thereof is approximately 1.5 mm, and the width thereof is approximately 1.5 mm, whereby it is possible to securely obtain a radiating area of 200000 mm² or more.

Furthermore, since the depth of the grooves 103a provided on the outer face of the radiating member 103 is shallow, 1.5 mm, as described above, in the case that the grooves 103a are filled with dust and dirt, the grooves can be cleaned easily and securely in a short time with an existing cleaning tool. According to an experiment conducted by the inventors, it has been confirmed that the depth of the above-mentioned grooves 103a is not limited to approximately 1.5 mm, but the cleaning performance can be improved, provided that the depth is 2 mm or less. The above-mentioned existing cleaning tool is a cleaning tool generally used.

The convex section 103h formed so as to constitute the above-mentioned groove 103a has a rounded shape with no edges as shown in FIG. 17B. In addition, the convex section 103h formed among the plurality of the above-mentioned grooves is not limited to have this shape but should only have a non-sharp shape. Hence, the convex section has a shape not injuring the user inadvertently even in the case that the user touches the above-mentioned radiating member 103 when replacing the illuminating device, for example.

Furthermore, the corner section 103b of the groove 103a provided on the outside face of the above-mentioned radiating member 103 is provided so that the depth of the convex section 103b becomes gradually shallower in a direction from the bottom face 103c to the cap 108 as shown in FIG. 15 in particular. In other words, the above-mentioned corner section 103b is formed into a tapered shape or a rounded shape, for example, whereby an existing cleaning tool can be applied to the groove 103a having the corner section 103b at which the cleaning starts; as a result, dust and dirt can be removed without causing insufficient cleaning. Consequently, since the corner section 103b having the rounded shape is provided as described above, the cleaning performance can be improved.

Furthermore, although the above-mentioned corner section 103b is provided at the one end section 103A of the radiating member 103, it is preferable that the corner section should also be provided at the other end section 103B having the mounting face 103d to further improve the cleaning performance. Hence, in the case that the corner section is provided at the above-mentioned other end section 103B, the corner section 103b is provided so that its shape becomes gradually shallower in a direction from the bottom face 103c to the cover 106 described later, whereby in the case that the above-mentioned illuminating device is installed in a direction perpendicular to a horizontal plane, such as a ceiling plane, dust and dirt can be removed without causing insufficient cleaning at the corner section 103b at which the cleaning is ended.

Since the grooves 103a provided on the outer face of the radiating member 103 are shallow and provided plural in number in the cleaning direction as described above, they can be cleaned easily, thereby being ideally suited for maintenance. By virtue of the corner section 103b of the above-mentioned groove 103a provided so as to have a rounded shape in a direction from the bottom face 103c to the cap 108, an existing cleaning tool can be applied to the above-mentioned groove 103a. In addition, in the case that the corner section is has a rounded shape in the direction from the bottom face 103c to the cover 106, the cleaning can be carried out without causing insufficient cleaning at the above-mentioned corner section 103b, whereby the cleaning performance can be improved.

Furthermore, although the above-mentioned grooves 103a are provided over the entire outer face of the radiating member 103, they may be provided partly. In the case that the grooves 103a are provided at least around the heat source, the radiating area can be obtained securely near the heat source, whereby the heat therefrom can be radiated to the outside air efficiently. In the case that the grooves 103a are provided partly near the heat source, the corner sections 103b are provided at both ends of each groove 103a on the above-mentioned radiating member 103; hence, in the case that the above-mentioned corner sections 103b are formed into a rounded shape or a tapered shape, the cleaning can be carried out without causing insufficient cleaning at the above-mentioned corner sections 103b, whereby the cleaning performance can be improved.

Moreover, the outer face of the radiating member 103 having the above-mentioned cylinder is formed so that its diameter is reduced slightly (or tapered) at an inclination angle of approximately 1° in a direction from the one end section 103A to the other end section 103B. Hence, in the case that the radiating member is produced by metal molding, the process of extracting it from a metal mold can be carried out easily, whereby the radiating member 103 having high accuracy can be mass-produced in a short time.

Since the mounting face 103d has a disc shape, the radiating member 103 has a hollow cylindrical shape; however, the radiating member may have a hollow polygonal shape, such as a hollow triangular shape or a hollow quadrangular shape. Similarly, the shape of the mounting face 103d is not limited to the disc shape, but the mounting face 103d may have a shape different from the external shape of the above-mentioned radiating member 103, for example. In other words, the mounting face 103d provided on the radiating member 103 having a hollow polygonal shape may have a disc shape.

In addition, the one end section 103A of the above-mentioned radiating member 103 has a screw-engaging shape so as to be screw-engaged with the connector 107 described later. Furthermore, the other end section 103B has the mounting face 103d, the outer circumferential section 103e of the above-mentioned mounting face 103d is slightly smaller than the external form of the radiating member 103, and the above-mentioned outer circumferential section 103e has a screw-engaging shape so as to be screw-engaged with the cover 106 described later. As a result, since screw engagement can be carried out without using fastening fittings, such as screws, the number of components can be reduced. Besides, the cost can also be reduced.

Still further, through-holes 103f, which are used for fastening using screws or the like and located at least at two positions corresponding to the through-holes 102b provided in the reflection plate 102 for supporting the LED module 101 on the mounting face 103d so that the LED module is held therebetween, are provided on the mounting face 103d of the above-mentioned radiating member 103, and the same screws 113a can be used to connect the reflection plate 102 and the mounting face 103d. This leads to reduction in the number of components, and the cost can be reduced. In addition, a first insulation sheet 112 is attached to the inner face or the inner circumferential face of the radiating member 103.

Next, the configurations of the LED module 101 and the reflection plate 102 to be mounted on the mounting face 103d of the radiating member 103 will be described. The above-mentioned LED module 101 is a pseudo-white LED module 101 in which a plurality of LED chips 101c (small chips) are mounted on a ceramic substrate 101a having a rectangular shape as shown in FIGS. 14 and 15 in particular. A resin containing a phosphor is used to seal the plurality of LED chips 101c. Since the phosphor is excited by the blue light emitted from the LED chips 101c and generates yellow light, the light emitted from the LED module 101 is visually recognized as white due to the blue light from the LED chips 101c and the yellow light from the phosphor.

In addition, the above-mentioned LED module 101 is supported at the center of the mounting face 103d of the radiating member 103 with the radiating sheet 110 held therebetween. Two LED module engaging holes 101d are provided at the end sections of the rectangular ceramic substrate 101a at the opposing corners thereof, and the LED module 101 is positioned on the above-mentioned mounting face 103d by fitting the LED module engaging holes 101d onto the positioning convex sections 103i provided on the mounting face 103d of the above-mentioned radiating member 103.

Furthermore, since the LED module 101 is supported on the mounting face 103d with the radiating sheet 110 held therebetween, the heat generated from the LED module 101 can be transferred to the radiating section 103, and the temperature rising of the LED module 101 can be suppressed. As a result, wire disconnection due to heat accumulation in the LED module 101 can be prevented, and it is thus possible to provide an LED module 101 having a long service life.

The above-mentioned reflection plate 102 is used to reflect the diffused light emitted from the LED module 101 as shown in FIGS. 14, 15 and 18 in particular, and is made of a high-reflection material formed into a plate shape, such as a polycarbonate resin. Since the reflection plate 102 supports the above-mentioned LED module 101 serving as a heat source on the mounting face 103d so that the LED module is held therebetween, in the case that reflection plate is made of a flame-retardant material, it is possible to provide an illuminating device having higher safety.

Furthermore, in the case that its surface is painted white, it can efficiently reflect the light emitted from the LED module 101 and diffused by the cover 106. Moreover, the reflection plate 102 is equipped with an extracting window 102a through which the light from the LED module 101 is extracted and is also equipped with protrusions 102c for holding the LED module 101 on the mounting face 103d so that the LED module is held therebetween at two corners of the extracting window 102a. As a result, in the case that the LED module 101 is supported on the mounting face 103d using the above-mentioned reflection plate 102 so as to be held therebetween, the LED module 101 and the reflection plate 102 can be mounted on the above-mentioned mounting face 103d without increasing the thickness of the assembly.

Through-holes 102b, which are used for fastening using screws or the like and located at least at two positions corresponding to the through-holes 103f provided in the mounting face 103d, are provided in the reflection plate 102 at the diagonal positions (excluding the inside of the extracting window 102a) of the extracting window 102a. Hence, in the case that the above-mentioned LED module 101 is supported on the mounting face 103d using the reflection plate 102 so as to be held therebetween, the same screws 113a used for the through-holes 103f provided in the mounting face 103d can be used for the mounting, whereby the number of components can be reduced and the cost can also be reduced.

Next, the configuration of the cover 106 and the mounting structure thereof will be described in detail. As shown in FIGS. 13 to 16 in particular, the above-mentioned cover 106 is made of a milky-white polycarbonate resin being excellent in heat resistance and has light transparency and light diffusivity. In addition, the above-mentioned cover 106 has a cylindrical shape; the length of the cylinder in the axial direction is approximately 30 mm, the thickness thereof is approximately 3 mm, the total light transmittance thereof is approximately 55%, and the dispersion ratio thereof is approximately 60%. Furthermore, as the diameter of the radiating member 103 is reduced, the diameter of the outer face of the cover 106 is reduced at an inclination angle of approximately 1° so that the cover is engaged with the above-mentioned radiating member 103.

Moreover, a top face 106a is provided on one side of the above-mentioned cover 106, and the top face 106a and the inner top face 106b thereof are formed so as to be swollen at the central sections thereof. Hence, the cover can have a slightly rounded shape and has a shape along the radiating member 103, whereby the appearances of the cover 106 and the illuminating device can be improved. Furthermore, since the shape is significantly different from that of the conventional illuminating device having a rounded shape, a fresh image can be provided for the user.

Moreover, on the other side of the cover 106, the cover has a shape so as to be screw-engaged with the screw-engaging shape provided on the outer circumferential section 103e of the radiating member 103. Since the inside diameter of the cover 106 is slightly larger than the outside diameter of the above-mentioned outer circumferential section 103e, the cover 106 is fitted on the outside of the outer circumferential section 103e and screw-engaged therewith via a sealing material. Hence, screw engagement can be carried out without touching the radiating member 103. Although the above-mentioned cover 106 has a cylindrical shape, the cover is not limited to have this shape but may have a dome shape or a hemispherical shape, for example.

Next, the configuration of the circuit board 104 accommodated in the radiating member 103 and the mounting structure thereof will be described. The above-mentioned circuit board 104 is formed of the power source circuit 104a and the drive circuit 104b and is provided so as to be accommodated in the radiating member 103 having the above-mentioned cylindrical shape as shown in FIGS. 15 and 16 in particular. Hence, the circuit board 104 can be accommodated inside the radiating member 103, whereby the illuminating device can be made compact. In addition, since a first insulation sheet 121 is provided on the inner face of the radiating member 103, the heat generated from the circuit board 104 is directly transferred to the radiating member 103 without electrically influencing the radiating member 103 and then released into the outside air via the grooves 103a provided on the outer face thereof. As a result, the heat radiation characteristics thereof can be improved. In addition, a second insulation sheet 122 is attached to the circuit board 104.

Furthermore, the circuit board 104 is inserted from the one end section 103A of the radiating member 103 and accommodated in the radiating member 103. Moreover, it is preferable that the circuit board 104 is equipped with light modulating means for changing the brightness of the illuminating device and is equipped with a thermal fuse for protecting the drive circuit 104b and a current fuse for carrying out protection by detecting the current value of the power source circuit 104a. Hence, in the case that a current exceeding the rated current flows because of abnormality, the above-mentioned current fuse detects the current and the above-mentioned thermal fuse detects the temperature, wherein the wires of the power source circuit 104a and the drive circuit 104b can be prevented from being disconnected by fusing, and the LED module 101 and the circuit board 104 can be prevented from being degraded. Besides, since the amount of the light can be adjusted depending on the location, use, etc., energy saving can be attained. Still further, since the above-mentioned thermal fuse and current fuse are provided, it is possible to provide a safe illuminating device.

In addition, since the above-mentioned circuit board 104 is supported using two spacers 105 that are used to maintain a predetermined distance from the mounting face 103d as shown in FIGS. 15 and 16, an optimal distance for heat radiation is securely obtained between the heat sources, and heat accumulation inside the radiating member 103 can be prevented, whereby the causes of failures due to heat can be reduced.

The above-mentioned spacers 105 are rod-shaped members made of an insulating material, for example, flame-retardant plastic, such as polybutylene terephthalate (PBT), or porcelain. Furthermore, one end of each spacer 105 is supported by the same screw 113a using the through-holes 103f and 102b provided in the mounting face 103d and the reflection plate 102, and the other end of each spacer 105 is connected to the through-hole 104c provided in the circuit board 104 and supported. Hence, the spacers 105 can be supported in a state in which a predetermined distance is securely obtained between the heat sources without being electrically influenced by the circuit board 104.

Furthermore, the above-mentioned predetermined distance is a distance capable of securely providing an inner space 111 in which the heat generated from the LED module 101 mounted on the mounting face 103d of the radiating member 103 and the heat generated from the circuit board 104 can convect sufficiently. Hence, the inner space 111 securely provided using the drive circuit 104b and the spacers 105 is formed inside the radiating member 103.

Moreover, in the supporting structure of the above-mentioned spacers 105, at least the two spacers 105 are used to support the mounting face 103d and the circuit board 104; however, in the case that the LED module 101 is mounted on the mounting face 103d and in the case that the above-mentioned LED module 101 is mounted in the circumferential direction of the mounting face 103d, it may be possible that the through-holes 102b and 103f supported using the same screw 113a are provided at the centers of the reflection plate 102 and the mounting face 103d and that the mounting face 103d and the circuit board 104 are supported using one spacer 105.

Next, the configurations of the connector 107 and the cap 108 and the mounting structures thereof will be described. The above-mentioned connector 107 is used to connect the radiating member 103 to the cap 108 described later and has a funnel shape as shown in FIGS. 13 to 16 in particular and is made of a noncombustible material, such as porcelain or glass, or PBT.

As described above, the radiating member 103 is made of a metal to radiate the heat from the heat sources, thereby having electrical conductivity. Hence, it is necessary that the above-mentioned connector 107 has electrical insulation properties between the cap 108 electrically connected to a commercial power source and the radiating member 103 made of a conductive member. In addition, the above-mentioned connector 107 has heat resistance so as to be prevented from being deformed by melting due to the heat transferred from the heat sources. For this reason, the connector 107 according to this embodiment is made of porcelain. Furthermore, unlike plastic, porcelain is a noncombustible material and is thus hardly ignited, thereby ensuring safety.

Moreover, both ends of the connector 107 having a funnel shape have a screw-engaging shape, one end of which is screw-engaged with the one end section 103A of the radiating member 103 and the other end of which is screw-engaged with the cap 108 described later. Since the inside diameter of the side to be screw-engaged with the radiating member 103 is slightly smaller than the outside diameter of the radiating member 103, the side is inserted into the inside of the radiating member 103 and screw-engaged via a sealing material. Since the inside diameter of the side to be screw-engaged with the cap 108 described later is slightly smaller than the outside diameter of the cap 108 described later, the side is inserted into the inside of the cap 108 and screw-engaged via a sealing material.

Besides, glaze is applied to the central section of the outer face of the connector 107 to provide soft texture and smoothness. The above-mentioned cap 108 has a cavity therein, one side of which is open and the other side of which has a bottom as shown in FIGS. 13 to 16 in particular. In addition, one side of the cap 108 has a screw-engaging shape so as to be screw-engaged with the above-mentioned connector 107. Furthermore, the other side thereof has a screw-engaging shape so as to be screw-engaged with a bulb socket. The other side of the above-mentioned cap 108 serves as one terminal, and the other terminal protrudes on the bottom face thereof while being insulated from the one terminal. The other terminal and the one terminal are electrically connected to the circuit board 104 via lead wires.

In addition, in the case that the illuminating device according to Embodiment 4 is screw-engaged with an existing bulb socket installed in a direction perpendicular to a horizontal plane, such as a ceiling, and used, since the LED module 101 having a high temperature is located below the cap 108 having a low temperature, it is possible to induce convection of the outside air along the grooves 103a provided in a direction perpendicular to the above-mentioned horizontal plane.

Although an embodiment in which LEDs are used as a light source is exemplified in Embodiment 4 as described above, the light source is not limited to LEDs, but other light sources, such as other semiconductor devices and EL (electroluminescence), may also be used.

In addition, since screw engagement is carried out via a sealing material between the cover 106 and the outer circumferential section 103e (the other end section 103B) of the radiating member 103, between the radiating member 103 and the connector 107, and between the connector 107 and the cap 108, even if cleaning is performed using a liquid, such as a chemical liquid, waterproof property is ensured. Hence, any liquid is prevented from entering the inside of the radiating member 103, whereby the causes of failures can be eliminated. Furthermore, the shape is not limited to the screw-engaging shape but should only be a shape capable of attaining connection without using fastening fittings, such as screws; for example, an engaging section, such as a convex section or a concave section, may also be provided.

Moreover, since the screw-engaging shape is provided, it is not necessary to use the screws 113a and 113b or a method, such as welding, for the connection; hence, assembling can be carried out easily and the number of components can be reduced; this leads to cost reduction. Since disassembling is also made possible, it is possible to replace individual components. Hence, for example, in the case that the cover 106 is replaced with a cover 106 being different in optical characteristics (for example, directivity, color and brightness), it is possible to provide an illuminating device having different optical characteristics. Furthermore, the shape is ideally suited for maintenance.

According to Embodiment 4, the cleaning performance of the grooves 103a provided on the outer face of the radiating member 103 can be improved as described above.

At the end, the results of an experiment conducted with respect to a radiating area required to sufficiently radiate the heat generated from the LED module 101 will be described. The experiment was conducted under the conditions that a plurality of LED chips 101c were mounted and that the LED module 101 having a thickness of 1 mm and an amount of heat generation of 8.65×10⁶W/m³was secured to the front side of a rectangular aluminum substrate while a radiating sheet 110 (having a heat conductivity of 5.0 W/m·K) having a thickness of 1 mm was held therebetween. Furthermore, the above-mentioned aluminum substrate having a heat conductivity of 237 W/m·K, a thickness of 1 mm and an area of 112×112 mm was cooled only by air using the outside air (having a heat conductivity of 5.8 W/m²·K). The above-mentioned air cooling was carried out only on the rear side of the above-mentioned aluminum substrate.

As a result of simulation conducted under the above-mentioned conditions, it is found that a radiating area, i.e., the rear area of the above-mentioned aluminum substrate, of 12500 mm² is required in the case of type 20 illuminating device, a radiating area of 25000 mm² is required in the case of type 40 illuminating device and a radiating area of 37500 mm2 is required in the case of type 60 illuminating device. In other words, in order that the radiating section suppresses the temperature rising of 40° C. or more by carrying out air cooling using the outside air, the area of the radiating member 103 making contact with the outside air and being air-cooled is required to be 12500 mm² in the case of type 20, 37500 mm² in the case of type 40 and 37500 mm² in the case of type 60. However, in actual use, under the consideration that air cooling is not carried out for a flat plane but carried out for the radiating grooves 103a radially provided in parallel on the radiating member 103 and that the accommodation section is hermitically sealed, it is desirable that the radiating area should be approximately 20000 mm² that is 60% larger than 12500 mm² in the case of type 20, for example.

### Embodiment 2

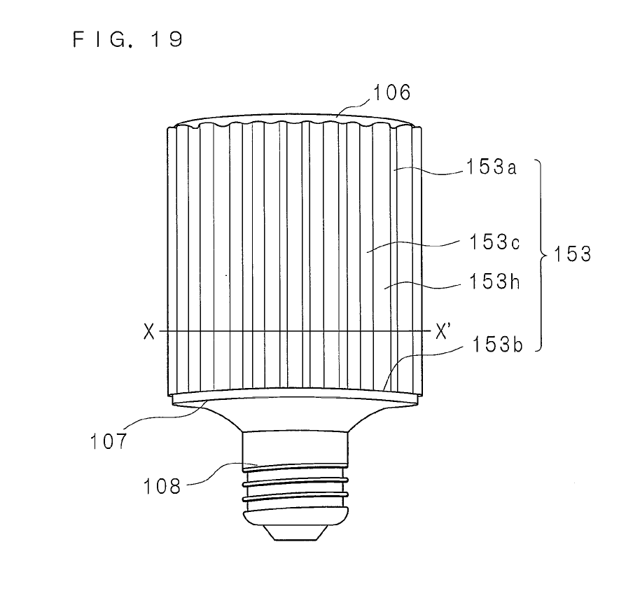

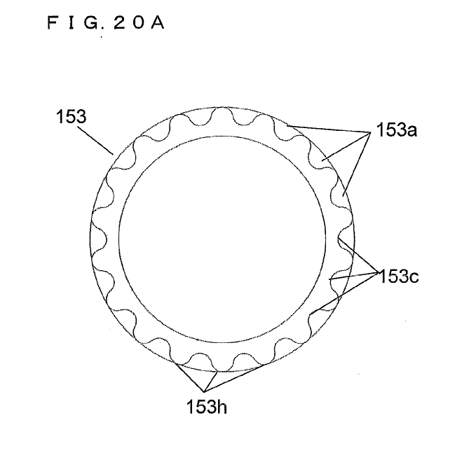

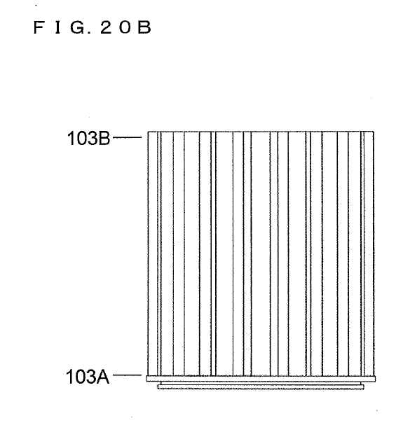

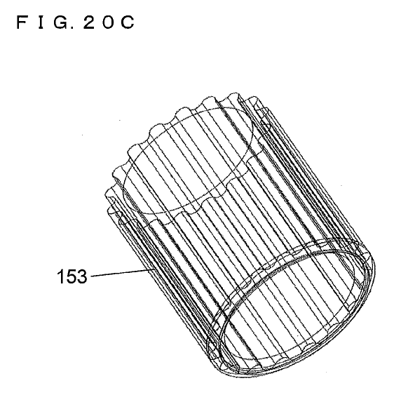

Embodiment 5 will be described below on the basis of FIGS. 19 and 20A to 20C. FIG. 19 is a front view showing the main section of an illuminating device equipped with a radiating member according to Embodiment 5 of the present invention. FIG. 20A is a sectional view showing the main section, taken on line X-X′ of the radiating member shown in FIG. 19, FIG. 20B is a front view showing the main section of the radiating member according to Embodiment 5 of the present invention, and FIG. 20C is a perspective view showing the main section of the radiating member according to Embodiment 5 of the present invention.

The illuminating device according to Embodiment 5 has a radiating member 153 different from that of the illuminating device according to Embodiment 4; since the other components of the illuminating device are the same as those according to Embodiment 4, they are designated by the same codes and their detailed descriptions are omitted.

The radiating member 153 according to this embodiment has a cylinder capable of accommodating the circuit board 104 therein as in the case of the radiating member 103 described in Embodiment 4, and the brightness of the LED module 101 and the outside diameter and the length of the cylinder are nearly identical with those described in Embodiment 4. Furthermore, the number of the grooves 153a provided on the outer face of the radiating member 153 is 18, the width of the groove is approximately 5 mm, and the depth thereof is approximately 8 mm. Hence, the depth of the above-mentioned groove is deeper and the width thereof is wider than those of the radiating member 103 described in Embodiment 4.

Hence, the width of the grooves 153a is made larger and the number thereof is reduced, whereby it is possible to provide the radiating member 153 having the grooves 153a that can be cleaned easily in a short time using an existing tool while securely obtaining a radiating area.

Furthermore, in Embodiments 4 and 5 described above, the radiating members 103 and 153 are formed into a hollow shape to accommodate the circuit board 104 and the inner space 111. However, in the case that it is not necessary to accommodate these, the shape is not limited to such a hollow shape, and wide application is possible to devices having other light sources and radiating mechanisms. Moreover, although the illuminating device has been described using the radiating unit that is formed by the combination of the above-mentioned radiating member 103 or 153 and the heat sources, wide application is also possible to other uses, such as drain pipes through which hot water flows and the combustion chambers of burners.

In Embodiments 4 and 5, in the radiating member having the grooves for radiating the heat of the heat sources on the outer face thereof, since the grooves are formed shallow so that the cleaning performance can be improved as described above, the grooves can be cleaned easily in a short time using an extracting tool.

Besides, in Embodiments 4 and 5, since the grooves provided on the radiating member are provided in plural number on the outer face of the radiating member in a constant direction, dust and dirt attached to the outer face of the radiating member can be removed easily by moving an existing cleaning tool in the constant direction.

What's more, in Embodiments 4 and 5, since the grooves provided on the radiating member are provided linearly on the outer face of the radiating member, dust and dirt accumulating therein can be removed easily using an existing cleaning tool, and cleaning can be carried out in a short time.

Still further, in Embodiments 4 and 5, since the grooves provided on the radiating member are provided in parallel with or perpendicular to the cleaning direction of the radiating member, dust and dirt accumulating therein can be removed easily using an existing cleaning tool, and cleaning can be carried out in a short time.

In addition, in Embodiments 4 and 5, since each of the grooves provided on the radiating member has at least one end on the outer face of the radiating member, wherein the depth of the groove at the one end becomes gradually shallower so that dust can be swept out; hence, in the case that dust and dirt accumulating therein is swept away using an existing cleaning tool, the cleaning tool can be applied to the corners of the groove; as a result, cleaning can be carried out without causing insufficient cleaning, and the cleaning performance thereof is excellent.

Furthermore, in Embodiments 4 and 5, since the grooves provided on the radiating member are provided at least around the heat sources, the radiating area can be securely obtained around the heat sources; hence, the heat of the heat sources can be radiated more efficiently to the outside air.

Moreover, in Embodiments 4 and 5, since the main body of the radiating member has a cylindrical shape, the heat sources, etc. can be mounted inside the cylinder; hence, the characteristics of radiating the heat from the above-mentioned heat sources can be improved, and the entire device can be made compact.

Besides, in Embodiments 4 and 5, since the diameter of the main body of the radiating member is reduced in a direction from the one end section of the cylinder to the other end section thereof, in the case that the radiating member is produced by metal molding, the process of extracting it from a metal mold can be carried out easily, whereby metal molding is can be made, and mass-production is made possible easily.

What's more, in Embodiments 4 and 5, since the outer face of the radiating member is painted, the radiating member can be made durable; in the case that the radiating member is painted white in particular, the characteristics of radiating the heat from the radiating member to the outside air can be improved.

Still further, in Embodiments 4 and 5, since the radiating unit and the illuminating device are equipped with the above-mentioned radiating member and the radiating member is equipped with shallow grooves, it is possible to provide a radiating unit and an illuminating device being excellent in cleaning performance.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

1-11. (canceled)

12. A connector for connecting a conductive member including a radiating section for radiating heat generated by a heat source which functions with supplied power, to a power source connection section connected to an external power source which supplies power to the heat source, wherein
the connector has electrical insulation properties to electrically insulate the conductive member and the power source connection section and has heat resistance so as to be prevented from being deformed due to heat from the heat source.

13. A connector for connecting a conductive member including a radiating section for radiating heat generated by a light source and/or a drive circuit section, to a cap connected to an external power source which supplies power to the light source, wherein
the connector has electrical insulation properties to electrically insulate the conductive member and the cap and has heat resistance so as to be prevented from being deformed due to heat.

14. The connector according to claim 13, wherein the connector has noncombustibility.

15. The connector according to claim 13, wherein the connector is made of porcelain.

16. The connector according to claim 13, wherein the connector has a first screw-engaging structure for screw-engaging the connector with the conductive member, and/or a second screw-engaging structure for screw-engaging the connector with the power source connection section or the cap.

17. The connector according to claim 16, wherein the first screw-engaging structure and/or the second screw-engaging structure are obtained by being formed a male thread on the connector.

18. The connector according to claim 17, wherein the convex section of the male thread has a rounded shape.

19. The connector according to claim 16 wherein the first screw-engaging structure and/or the second screw-engaging structure are provided with a sealing material for screw-engaging.

20. The connector according to claims 16, wherein the connector is coated with glaze.

21. An illuminating device equipped with the connector according to claim 12.

22. An illuminating device equipped with the connector according to claim 13.

23. An illuminating device equipped with the connector according to claim 16.

24. An illuminating device equipped with the connector according to claim 17.

25. An illuminating device equipped with the connector according to claim 18.

26. An illuminating device equipped with the connector according to claim. 19.

27. An illuminating device equipped with the connector according to claim 20.

28. The illuminating device according to claim 23, wherein the light source is a light-emitting diode.

29. The illuminating device according to claim 24, wherein the light source is a light-emitting diode.

30. The illuminating device according to claim 25, wherein the light source is a light-emitting diode.

31. The illuminating device according to claim 26, wherein the light source is a light-emitting diode.
